(19) United States
(12) Patent Application Publication
(10) Pub. No.: US 2002/0025401 A1
(43) Pub. Date: Feb. 28, 2002

(54) Optical storage using materials comprising chromophore oligomers which can undergo cycloaddition

(76) Inventors: Rolf Berg, Rungsted Kyst (DK); P.S. Ramanujam, Roskilde (DK)

Correspondence Address: BIRCH STEWART KOLASCH & BIRCH, PO BOX 747, FALLS CHURCH, VA, 22040-0747, US

(21) Appl. No.: 09/882,030

(22) Filed: Jun. 18, 2001

(30) Foreign Application Priority Data
Jun. 16, 2000 (DK) PA 2000 00941

(51) Int. Cl. G11B 5/09; G11B 5/52; B32B 3/02

(52) U.S. Cl. 428/64.3; 369/47.5

(57) ABSTRACT

The present invention relates a method for optical storage of information using materials comprising compound having at least two chromophores and a linkage connecting the chromophores. The optical storage method can be effected by use of light having a wavelength of from 100-1600 nm. The compound applicable for the method are typically dimers based on a skeleton made of peptides or amino acids, or alternatively peptide nucleic acid (PNA). The chromophores may thymine, N—(C₁₋₆-alkyl)-thymine, anthracene, acridizinium salts, tetracene, etc.

### FIELD OF THE INVENTION

The present invention relates to a method for optical storage in a material comprising compounds having at least two chromophores (“OPTIDES”). The OPTIDES are typically constructed of amino acids and peptides which contain chromophores that can undergo photo-induced cycloaddition reactions and which, when presented in solid materials, have highly interesting optical properties. In particular, the invention is also directed to materials comprising such compounds, which are especially suited for optical storage of information.

### BACKGROUND OF THE INVENTION

Optical storage represents unique opportunities for storing data at high density. Currently available magneto-optical materials may not be viable for high-density reversible optical storage in the future due to their toxicity. Furthermore, emphasis is being put on the use of organic materials instead of the inorganic, since these are more easily recyclable and hence less polluting. It is believed that organic polymer materials will be used extensively in future data storage systems. However, the fact is that optical storage technology presently suffers from an absence of practical organic materials that apply to the next generation of commercially available laser diodes, namely the blue ones that operate between 400 and 500 nm. Looking further into the future, ultra-high density optical storage will move towards the use of even shorter wavelengths. Thus, using a frequency quadrupled YAG laser at 266 nm, and the UV diode lasers under development, a storage of >20 Gbytes can in principle be achieved in a single CD.

A large amount of work has been done on azo polymers for optical information storage [Angeloni et al., Liq. Cryst. 4, 513 (1989); Eich et al., Makromol. Chem. rapid Commun. 8, 59 (1987); Shibaev et al., Vysokomol. Soyed. A32, 1552 (1990); Natansohn et al., Macromolecules 25, 2268 (1992); Haitjema et al., Macromolecules 27, 6201 (1994)]. Liquid crystalline side-chain polyesters as well as side-chain amorphous polyesters have also been investigated [Hvilsted et al., Optics Letters 17, 1234 (1992); Hvilsted et al., Macromolecules 28, 2172 (1995); Holme et al., Optics Letters 21, 902 (1996).; Ramanujam et al., Polymers for Advanced Technologies 7, 768 (1996)]. One hindrance to the use of liquid crystalline polymers for use with digital data storage is the presence of liquid crystalline domains, which scatter light and give rise to background noise. In amorphous polymers with no liquid crystallinity, on the other hand, it has been found that the induced anisotropy decays over a period of months. Furthermore, azobenzenes can normally not be used at wavelengths below 400 nm. We have previously developed peptides modified with photo-addressable side-chain chromophores as materials for optical storage [Berg et al., Nature 383, 505 (1996); Rasmussen et al., J. Am. Chem. Soc. 121, 4738 (1999); Rasmussen et al, Tetrahedron Lett. 40, 5953 (1999)]. Peptides are an excellent choice since they meet several important criteria as materials. Peptide films are normally completely transparent and they are amorphous. In many cases, they are water soluble and are environmentally friendly. The potential of this new approach was limited in earlier studies to the use of photoisomerisable chromophores such as azobenzenes.

Photodimerisation in crystals has been known for a long time. The crystals have been tested for holographic storage; however, these materials are mechanically fragile [Tomlinson et al., Appl. Opt. 11, 533 (1972)].

It is known [Wulff & Fraenkel, Biochem. Biophys. Acta 51, (1961)] that one of the four bases in DNA, thymine, can dimerise via (2π+2π) cycloaddition on exposure to 266 nm (FIG. 1) This wavelength is exactly the quadruple of a YAG laser (1064 nm). Small frequency quadrupled YAG lasers are available on the market today. Furthermore, solid state UV lasers are under development. Photodimerisation of thymine monomers attached to alkyl chains have been proposed as photoresists [Inaki et al., J. Photopolym. Sci. Tech. 1, 28 (1988)]. Also, multifunctional vinylbenzyl and vinylphenyl pendant thymine (and uracil) groups have been found useful in photoresist; images in the polymer are provided by exposure to actinic radiation, containing such polymer and by solvent removal of non-exposed regions [Grasshoff et al., U.S. Pat. No. 5,708,106].

### BRIEF DESCRIPTION OF THE INVENTION

The present invention provides a method for optical storage of information and subsequent read-out. Thus, the present invention provides a method for optical storage of information in a material and optical read-out of the information from said material, said material comprising a compound having at least two chromophores and a linkage connecting the chromophores, said method comprising:

(a) irradiation of localised areas of the material at a first wavelength with a first intensity thereby inducing a cycloaddition reaction between chromophores in said localised areas of the material whereby a cycloadduct is formed, and

(b) irradiation of the material at a second wavelength with a second intensity thereby rendering it possible to extract the information, or a part thereof, from the material.

It is found that a refractive index change in a material can be obtained through photodimerisation of neighbouring chromophores that are able to undergo (2π+2π) cycloadditions. The photodimers or photooligomers (OPTIDES) are grainless, stable in both states and are photoerasable. As will be understood from the following, the present invention proposes to utilise photodimerisation processes to achieve high-density optical storage. The photodimerisable molecules (chromophores) are in one embodiment attached to a short peptide skeleton, such as a diamino acid-N^{α}-substituted oligopeptide developed for optical storage at visible wavelengths. The two (or more) chromophores are thus closely situated thereby facilitating the formation of a dimer (or dimers) on exposure to UV light. This process is in principle completely reversible. On exposure to shorter wavelengths, the chromophores may be reproduced. Hence, an optical process for erasure can also be applied. The advantage of the method of the invention, and the materials in particular, is that no complicated and difficult crystal growth is necessary. Liquid crystallinity is not necessary for optical storage, thus eliminating the problem of light scattering due to the presence of domains. The material prepared in the form of a film is typically completely transparent. The use of relatively simple oligomers will make the cost of fabrication minimal.

The present invention also relates to subgroups of novel compounds and to materials comprising such compounds.

### BRIEF DESCRIPTION OF THE FIGURES

FIG. 1 Chemical structure of dno-716 (contains thymine chromophores).

FIG. 2 Chemical structures of dno-716, dno-718, and dno-720 (dno-719 is not shown, but its chemical structure corresponds to n=1).

FIG. 3 Chemical structure of dno-717 (contains anthracene chromophores).

FIG. 4 Chemical structure of pna-1000 (contains thymine chromophores).

FIG. 5. Chemical structure of dno-716 before irradiation and the proposed cycloaddition reaction product of dno-716 upon irradiation. The two side-chain thymine chromophores dimerise via (2π+2π) cycloaddition, presumably in a cis-syn configuration. The figure (lower part) also shows a proposed photodimerised product of dno-821.

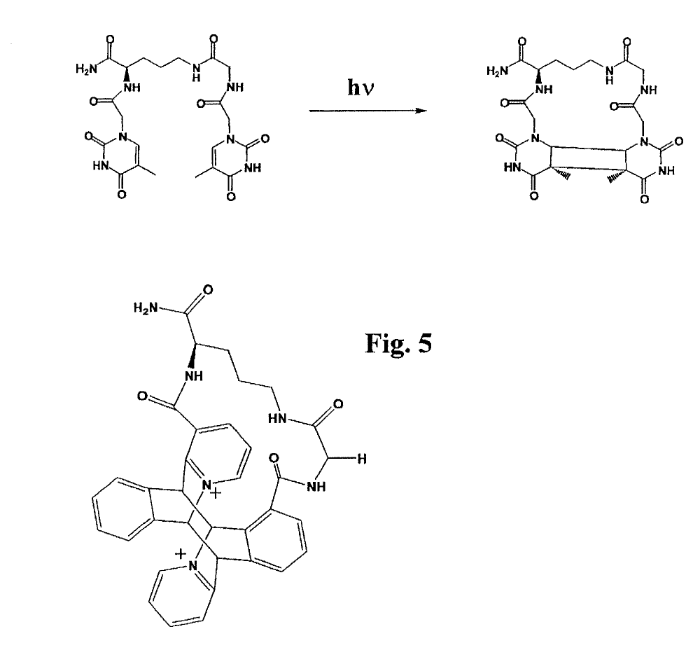

FIG. 6 Chemical structure of pna-1001 (contains N-methylated thymine chromophores).

FIG. 7 Chemical structure of dno-816 (identical to dno-716 except that it contains N-methylated thymine chromophores).

FIG. 8 Chemical structure of dno-817 (contains tetracene chromophores).

FIG. 9 Chemical structures of dno-818, dno-819, dno-820 and dno-821 (contain acridizinium chromophores positioned in different ways).

FIG. 10 Absorption spectrum of a thin film of dno-716. Curve 1 is the absorption due to an unirradiated film. Curve 2 is the absorption in a film irradiated with 1500 pulses at 248 nm. This corresponds approximately to an energy of 2 J/cm². Curve 3 is the absorption in a film irradiated with 3000 pulses at 248 nm. This corresponds approximately to an energy of 4 J/cm².

FIG. 11 Absorption spectrum of a thin film of dno-718. Curve 1 is the absorption due to an unirradiated film. Curve 2 is the absorption in a film irradiated with 1500 pulses at 248 nm. This corresponds approximately to an energy of 2 J/cm². Curve 3 is the absorption in a film irradiated with 3000 pulses at 248 nm. This corresponds approximately to an energy of 4 J/cm².

FIG. 12 Absorption spectrum of a thin film of dno-719. Curve 1 is the absorption due to an unirradiated film. Curve 2 is the absorption in a film irradiated with 1500 pulses at 248 nm. This corresponds approximately to an energy of 2 J/cm². Curve 3 is the absorption in a film irradiated with 3000 pulses at 248 nm. This corresponds approximately to an energy of 4 J/cm².

FIG. 13 Absorption spectrum of a thin film of dno-720, Curve 1 is the absorption due to an unirradiated film. Curve 2 is the absorption in a film irradiated with 1500 pulses at 248 nm. This corresponds approximately to an energy of 2 J/cm². Curve 3 is the absorption in a film irradiated with 3000 pulses at 248 nm. This corresponds approximately to an energy of 4 J/cm².

FIG. 14 Absorption spectrum of a thin film of pna-1000. The material was dissolved in hexafluoroisopropanol and cast into a film. Curve 1 is the absorption due to an unirradiated film. Curve 2 is the absorption in a film irradiated at 266 nm for 600 s. Curve 3 is the absorption in the film after it has been kept at 100 ° C. for 72 hours.

FIG. 15 Absorption spectrum of a thin film of pna-1000. The material was dissolved in distilled water and cast into a film. Curve 1 is the absorption due to an unirradiated film. Curve 2 is the absorption spectrum after the film has been irradiated at 266 nm for 600 s and then kept in the oven at 100° C. for 96 hours.

FIG. 16 Absorption spectrum of dno-717. Curve 1 is the absorption spectrum of an unirradiated film and curve 2 is the absorption spectrum of the film after it has been irradiated at 350 nm for 600 s.

FIG. 17 Transmission through a film of dno-717 of a 5 mW laser beam from a krypton laser at 350 nm. The film was cast close to the periphery of a Petri dish. The central portion of the film was then irradiated at 350 nm for 600 s. The large drop in the transmission is due to the absorption of light by the monomers; the central increase is due to the increased transmission by the dimers. 400 read cycles have been performed without degradation of the signal to noise ratio.

FIG. 18 Atomic force microscope scan of an interference grating recorded in a thin film of dno-717. The grating was created at 360 nm from an argon ion laser with the same polarisation. The grating period is roughly one micron. The height of the surface relief is approximately 90 nm.

FIG. 19 Atomic force microscope scan of a film of dno-717 irradiated at 360 nm from an argon ion laser through a transmission mask. The irradiated areas appear as trenches. The depth of the trenches is approximately 300 nm.

FIG. 20 Atomic force microscope scan of a film of dno-717 irradiated through the transmission mask at 360 nm and then kept in an oven at 110° C. for 16 hours. The depth of the trenches is approximately 200 nm.

### DETAILED DESCRIPTION OF THE INVENTION

As mentioned above, the present invention in one aspect relates to a method for optical storage of information in a material and optical read-out of the information from said material, said material comprising a compound having at least two chromophores and a linkage connecting the chromophores, said method comprising:

(a) irradiation of localised areas of the material at a first wavelength with a first intensity thereby inducing a cycloaddition between chromophores in said localised areas of the material, and

(b) irradiation of the material at a second wavelength with a second intensity thereby rendering it possible to extract the information, or a part thereof, from the material.

In order for the chromophores to undergo a cycloaddition reaction, the chromophores should at least include one double bond which can add to another double bond, thereby forming a so-called cycloadduct. Various types of cycloaddition reactions are known, e.g. the cycloaddition reaction may involve 4n electrons or the cycloaddition reaction involves 4n+2 electrons or the cycloaddition reaction is a 2π+2π cycloaddition reaction or the cycloaddition reaction is a 4π+4π cycloaddition reaction. In some interesting embodiments, e.g. as illustrated in the examples, the cycloaddition reaction involves chromophores having multiple bonds conjugated to aromatic rings or the cycloaddition reaction involves chromophores having multiple bonds incorporated in aromatic systems.

Interesting embodiments are also those where cycloaddition reaction between chromophores is reversible. In particular, the cycloadduct can dissociate, such as on irradiation or on heating, thereby reforming the chromophores.

The compounds applicable for the materials are generally compounds having at least two chromophores and a linkage connecting the chromophores. Although it is believed that the number of chromophores within one molecule can be more than two, such as up to 24 (preferably an even number), or more, preliminary considerations and experiments have shown that the best results are obtained for compounds comprising exactly two chromophores,

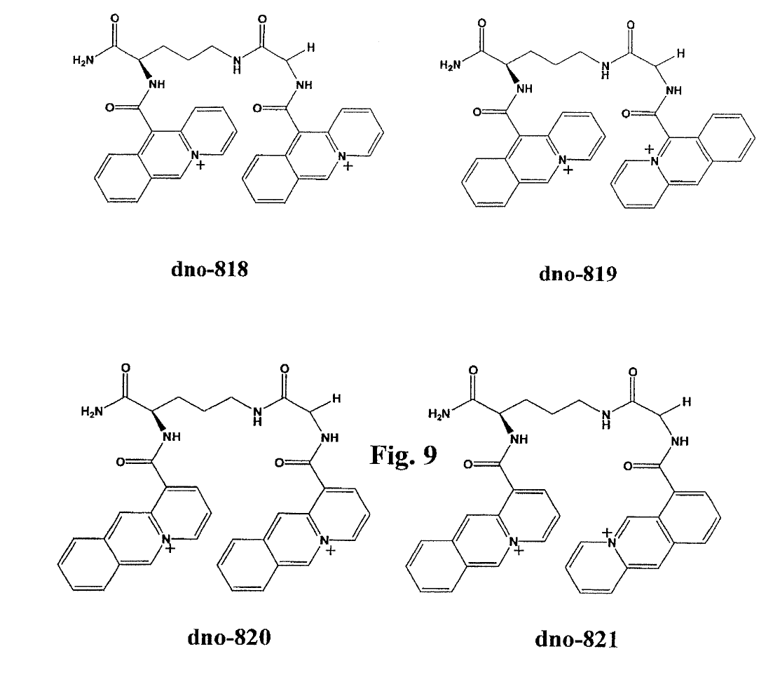

The two or more chromophores of the compounds may in principle be different as long as they are able to form mutual cycloaddition reaction products (cycloadducts). However, for most practical purposes, the compounds comprise only one type of chromophores, in particular chromophores which are substantially identical. By “substantially identical” is meant that the chromophores have the same general structure, but may be linked differently to the so-called backbone (see, e.g., FIG. 9).

In the present context, the term “chromophore” is intended to mean that the group in question absorbs light at wavelengths between 100 nm and 1600 nm, in particular between 200 nm and 700 nm, and that the group as a result of light absorption is able to undergo a reversible or irreversible, preferably reversible, cycloaddition reaction, e.g., a 2π+2π cycloaddition reaction.

The chromophores to be used herein can be selected from a broad range of compound classes, e.g. acyclic, cyclic, bicyclic, tricyclic, tetracyclic, polycyclic, heterocyclic, aromatic, polyaromatic and heteroaromatic compounds containing at least one double bond as will be recognised by those familiar with photochemistry. More specific examples of compounds are carbonyl compounds, dicarbonyl compounds, phenones, quinones, thiones, norbornadienes, pyrimidines, alkenes, bisthymines, maleimides, coumarins, furans, isobenzofuran, furocoumarins, pyrones, cinnamates, biscinnamates, phenanthrenes, bisphenanthrenes, acenaphthylenes, bisacenaphthylenes, azaanthracenes, acenes, naphthacenes, benzanthracenes, such as, e.g. acridizinium salts, benzacridizinium salts, thymine, N—C₁₋₆-alkyl-thymine, such as N-methyl-thymine, α-pyrone, 2-pyridon, N-2-methyl-pyridon, uracil, naphthalene, anthracene, 2-aminopyridinium, pyrazinone, benz[b]acridine, 2-phenylbenzoxazole, silacyclopentadiene, etc., said chromophores may independently be optionally substituted with one or more substituent(s) each independently selected from hydroxy, halogen such as fluorine, chlorine, bromine, and iodine, linear or branched optionally substituted C₁₋₆-alkyl, optionally substituted C₁₋₆-alkoxy, cyano, nitro, amino, mono- or di(optionally substituted C₁₋₆-alkyl)amino, mono- or di(optionally substituted C₁₋₆-alkyl)amino-C₁₋₆-alkyl, (optionally substituted C₁₋₆-alkyl)carbonylamino, (optionally substituted C₁₋₆-alkyl)carbonylamino-C₁₋₆-alkyl, aminocarbonyl, aminocarbonyl-C₁₋₆-alkyl, mono- or di(optionally substituted C₁₋₆-alkyl)aminocarbonyl, mono- or di(optionally substituted C₁₋₆-alkyl)aminocarbonyl-C₁₋₆-alkyl, optionally substituted C₁₋₆-acyl, optionally substituted C₁₋₆-acyloxy, carboxy, —COSH, (optionally substituted C₁₋₆-alkoxy)carbonyl, thiolo, C₁₋₆-alkylthio, optionally substituted C₁₋₆-alkylthio-C₁₋₆-alkyl, guanidino, isocyano, isothiocyano, and thiocyano.

Particular examples of chromophores are aromatic, polyaromatic and heteroaromatic compounds, e.g. napthalene, anthracene, tetracene, pentacene, thymine, N-methyl-thymine, uracil, acridizinium salts, benzacridizinum salts, 2-aminopyridinium, such as anthracene, acridizinium salts, N-methyl-thymine and tetracene.

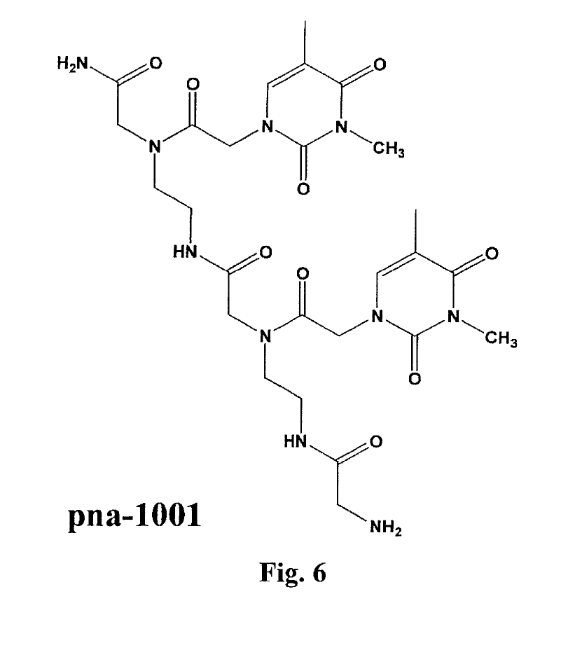

In one embodiment, the chromophore is not a nucleobase-binding group. Thus, the chromophore is not a moiety that can bind to a complementary position in DNA or RNA. One such example would be N-methyl-thymine (c.f., FIG. 6), which (in contrast with thymine) cannot bind to a nucleobase since it contains no hydrogen bond donor (—NH) group.

With respect to the linkage between the at least two (preferably two) chromophores, it may be based on (a) amino acids or peptides, e.g. α- and β-amino acids having ω-aminoalkyl side chains, such as ornithine, lysine, homolysine, diaminobutyric acid, and diaminopropionic acid; (b) ribonucleotides, deoxyribonucleotides, deoxyribonucleic acids, ribonucleic acids, and derivatives thereof such as LNA, in particular such where the chromophores takes the position of the nucleobases; and (c) polymer nucleic acids (PNA), in particular such of (b) and (c) where the chromophores takes the position of the nucleobases. The linkage between two “neighbouring” chromophores typically represents a length of 4-30 bonds, preferably 4-20 bonds, in particular 5-15 bonds.

One class of compounds for potential use within the present invention is represented by compounds comprises 2-24 segments of the following formula G

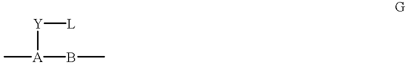

wherein

L is the photodimerisable chromophore;

Y-A-B is a part of the linkage between two chromophores, wherein

Y is a linking group selected from —O—(CH₂)ₚ—C(═O)—NH—, —O—(CH₂)ₚ—NH—C(═O)—, —O—(CH₂)ₚ—C(═O)—, —O—(CH₂)ₚ—NH—, —(CH₂)ₚ—C(═O)—NH—, —(CH₂)ₚ—NH—C(═O)—, —(CH₂)ₚ—C(═O)—, —(CH₂)ₚ—NH—, —OOC—(CH₂)ₚ—C(═O)—NH—, —OOC—(CH₂)ₚ—NH—C(═O)—, —OOC—(CH₂)ₚ—C(═O)—, —OOC—CH₂)ₚ—NH—, —NH—(CH₂)ₚ—C(═O)—NH—, —N(C₁₋₆-alkyl)-(CH₂)ₚ—C(═O)—NH—, —NH—(CH₂)ₚ—NH—C(═O)—, —N(C₁₋₆-alkyl)-(CH₂)ₚ—NH—C(═O)—, —NH—(CH₂)ₚ—C(═O)—, —N(C₁₋₆-alkyl)-(CH₂)ₚ—C(═O)—, —NH—(CH₂)ₚ—NH—, —N(C₁₋₆-alkyl)-(CH₂)ₚ—NH—, —NH—C(═O)—(CH₂)_{y}—C(═O)—NH—, —N(C₁₋₆-alkyl)-C(═O)—(CH₂)ₚ—C(═O)—NH—, —NH—C(═O)—(CH₂)ₚ—NH—C(═O)—, —N(C₁₋₆-alkyl)-C(═O)—(CH₂)ₚ—NH—C(═O)—, —NH—C(═O)—(CH₂)ₚ—C(═O)—, —N(C₁₋₆-alkyl)-C(═O)—(CH₂)ₚ—C(═O)—, —NH—C(═O)—(CH₂)ₚ—NH—, and —N(C₁₋₆-alkyl)-C(═O)—(CH₂)ₚ—NH—, wherein p is 0-5, preferably 0-2;

A is selected from a nitrogen atom and a group C—R in which R is selected from hydrogen and optionally substituted C₁₋₄-alkyl; and

B is a chain consisting of groups selected from CHR² and C═O, wherein R² is selected from side chains of α-amino acids, optionally substituted C₁₋₆-alkyl, hydroxy, optionally substituted C₁₋₆-alkoxy, halogen, cyano, amino, mono- or di(optionally substituted C₁₋₆-alkyl)amino, mono- or di(optionally substituted C₁₋₆-alkyl)amino-C₁₋₆-alkyl, (optionally substituted C₁₋₆-alkyl)carbonylamino, (optionally substituted C₁₋₆-alkyl, aminocarbonyl, aminocarbonyl-C₁₋₆-alkyl, mono- or di(optionally substituted C₁₋₆-alkyl)aminocarbonyl, mono- or di(optionally substituted C₁₋₆-alkyl)aminocarbonyl-C₁₋₆-alkyl, optionally substituted C₁₋₆-acyl, optionally substituted C₁₋₆-acyloxy, carboxy, and (optionally substituted C₁₋₆-alkoxy)carbonyl; said chain B optionally being interrupted, initiated, or terminated by one or more groups selected from —O—, and —NR³—, wherein R³ is selected from hydrogen, C₁₋₆-alkyl, mono- or di(optionally substituted C₁₋₆-alkyl)amino-C₁₋₆-alkyl, (optionally substituted C₁₋₆-alkyl)carbonylamino-C₁₋₆-alkyl, aminocarbonyl-C₁₋₆-alkyl, mono- or di(optionally substituted C₁₋₆-alkyl)aminocarbonyl, mono- or di(optionally substituted C₁₋₆-alkyl)aminocarbonyl-C₁₋₆-alkyl, (optionally substituted aryl)-C₁₋₆-alkoxycarbonyl, optionally substituted C₁₋₆-acyl, and optionally substituted C₁₋₆alkoxycarbonyl.

In the present context, the term “C₁₋₄-alkyl” designates a radical of a linear or branched or, although in contrast to custom use, cyclic aliphatic chain having from 1 to 4 carbon atoms, such as methyl, ethyl, 1-propyl, 2-propyl, 1-butyl, 2-butyl, tert-butyl, and cyclobutyl. Similarly, the term “C₁₋₆-alkyl” designates a radical of a linear or branched or cyclic aliphatic chain having from 1 to 6 carbon atom, such as the radicals mentioned for C₁₋₄-alkyl and pentyl, isopentyl, neopentyl, hexyl, and cyclohexyl. The longer variants of “alkyl” such as “C₁₋₂₄-alkyl”, “C₁₋₁₈-alkyl” and “C₁₋₁₂-alkyl” have corresponding meanings, and in particular includes the straight chain isomers.

In the present context, the terms “C₁₋₄-alkoxy” and “C₁₋₆-alkoxy” and high variants are intended to mean C₁₋₄-alkyl-oxy and C₁₋₈-alkyl-oxy, etc., respectively.

In the present context, the term “C₁₋₆-acyl” and designates alkanoyl, such as formyl, acetyl, propionyl, butyryl, isobutyryl, valeryl, isovaleryl, pivaloyl and hexanoyl. Higher variants have similar meanings.

In the present context, the term “aryl” is intended to mean a carbocyclic aromatic ring or ring system, such as phenyl, naphthyl, fluorenyl, and tetralinyl.

In the present context, the term “optionally substituted” in connection with “aryl” and “heterocyclyl” is intended to mean aryl and heterocyclyl, respectively, as defined above which may be substituted with one or more, preferably 1-3, substituents selected from hydroxy, C₁₋₄-alkyl and C₁₋₄-alkoxy which may be substituted one or more times with halogen (such as fluorine, chlorine, bromine, and iodine), hydroxy, amino, cyano, and carboxy, halogen (fluorine, chlorine, bromine, and iodine), nitro, nitroso, cyano, amino, mono- or di(C₁₋₄-alkyl)amino, aminocarbonyl, mono- or di(C₁₋₄-alkyl)aminocarbonyl, C₁₋₆-acyl, C₁₋₆-acyloxy, carboxy, C₁₋₄-alkoxycarbonyl, thiolo, C₁₋₄-alkylthio, arylthio, C₁₋₄-alkylsulphonyl, arylsulphonyl, mono- or di(C₁₋₄-alkyl)aminosulphonyl, sulphono (SO₃H), sulphino (SO₂H), halosulphonyl, isocyano, isothiocyano, and thiocyano.

In the present context, the term “optionally substituted” in connection with “alkyl”, “alkoxy”, and “acyl” is intended to mean that the group in question may be substituted one or more times with hydroxy, C₁₋₄-alkoxy optionally substituted one or more times with halogen (fluorine, chlorine, bromine, and iodine), hydroxy, amino, cyano, and carboxy, halogen (fluorine, chlorine, bromine, iodine), nitro, nitroso, cyano, carboxy, thiolo, C₁₋₄-alkylthio, arylthio, C₁₋₄-alkylsulphonyl, arylsulphonyl, sulphono (SO₃H), sulphino (SO₂H), halosulphonyl, isocyano, isothiocyano, and thiocyano.

In the present context, the term “side chains of α-amino acids” is intended to mean a group bound to the α-atom of an α-amino acids, i.e. the α-amino acid in question without the glycine moiety, preferably an either naturally occuring or a readily available α-amino acid. Most interesting are the side chains of commercially available α-amino acids, e.g., the naturally occuring α-amino acids such as alanine, valine, norvaline, isovaline, leucine, norleucine, isoleucine, methionine, phenylalanine, tryptophan, serine, threonine, cysteine, penicillamine, tyrosine, asparagine, glutamine, aspartic acid, glutamic acid, ornithine, lysine, arginine, histidine, proline, 4-hydroxy-proline, and pipecolic acid.

A more particularly class of compounds is represented where A is selected from a nitrogen atom and a group C—H; and B is a chain consisting of groups selected from CHR² and C═O, wherein R² is selected from hydrogen and side chains of α-amino acids; said chain B optionally being interrupted, initiated, or terminated by one or more groups selected from —O—, and —NR³—, wherein R³ is selected from hydrogen, C₁₋₆-alkyl, C₁₋₆-acyl, and amino protecting groups such as tert-butoxycarbonyl (Boc) or 9-fluorenylmethyloxycarbonyl (Fmoc).

As will be understood, in particular with respect to the ease of synthesis, a particular class of compounds is characterised by the fact that the backbone moiety -A-B- together with at least a part of the linking group Y is derived from one or more amino acid(s), in particular from an amino acid selected from ornithine, homolysine, lysine, diaminobutyric acid, and diaminopropionic acid, in particular ornithine.

Although the compounds may include up to 24 segments, it is typically preferred that the compounds comprise 2-20 segments, preferably 2-10 segments, e.g. 2-6 segments, such as 2-4 segments, preferably 2 segments, of the formula G.

A more specific class of compounds is the one characterised by the formula G^{h}

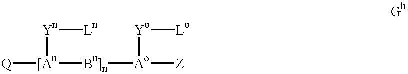

wherein n is a positive integer, e.g. in the range of 1-19, such as in the range of 1-9, e.g. 2; each of Y⁰, . . . , Yⁿ independently is a linking group as defined above; each of L⁰, . . . , Lⁿ independently is a chromophore; each of A⁰, . . . , Aⁿ independently is a group as defined for A as defined above; each of B¹, . . . , Bⁿ independently is a chain as defined for B above; and Q and Z are terminating groups.

The groups Q and Z are typically each independently selected from the same groups as defined for R² and R³above, optionally substituted with a chain consisting of 1 to 5 amino acids, or extended by a chain as defined for B above; and, when one or both of the group(s) Q and Z are part of a carbocyclic or heterocyclic ring or a macrocycle, Q and/or Z is/are selected from the biradicals of the before-mentioned groups and a single bond. The groups Q and Z does not have direct influence on the cycloaddition reaction, but may have influence on the arrangement of the chromophores before cycloaddition and thereby on the reaction rate and efficiency.

When A is C—R, the group Z is typically selected from side chains of α-amino acids, hydrogen, methyl, cyanomethyl, ethyl, 1-propyl, 2-propyl, 2-methyl-1-propyl, 2-hydroxy-2-methyl-1-propyl, 1-butyl, 2-butyl, methylthioethyl, benzyl, p-amino-benzyl, p-iodo-benzyl, p-fluoro-benzyl, p-bromo-benzyl, p-chloro-benzyl, p-nitro-benzyl, 3-pyridylmethyl, 3,5-diiodo-4-hydroxy-benzyl, 3,5-dibromo4-hydroxy-benzyl, 3,5-dichloro4-hydroxy-benzyl, 3,5-difluoro-4-hydroxy-benzyl, 4-methoxy-benzyl, 2-naphtylmethyl, 1-naphtylmethyl, 3-indolylmethyl, hydroxymethyl, 1-hydroxyethyl, mercaptomethyl, 2-mercapto-2-propyl, 4-hydroxybenzyl, aminocarbonylmethyl, 2-aminocarbonylethyl, carboxymethyl, 2-carboxyethyl, aminomethyl, 2-aminoethyl, 3-amino-propyl, 4-amino-1-butyl, 3-guanidino-1-propyl, 4-imidazolylmethyl, C₁₋₂₄-alkyl, N—(C₁₋₂₄-acyl)-amino-(C₁₋₆-alkyl), and (a chain of 1-5 amino acid(s))-amino-(C₁₋₆-alkyl), and 1,3-propylene, 2-hydroxy-1,3-propylene, or 1,4-butylene forming a pyrrolidine ring, a 3-hydroxy-pyrrolidine ring, or a piperidine ring, respectively, involving A and a nitrogen atom of Y adjacent to A; and, when A is N, the group Z is typically selected from hydrogen, amino-C₁₋₄-alkyl, N-mono- or di(C₁₋₂₄-alkyl)-amino-C₁₋₄-alkyl, C₁₋₂₄-acylamino-C₁₋₄-alkyl, and (a chain of 1-5 amino acids)-amino-C₁₋₄-alkyl.

The term “a chain of 1-5 amino acids” is intended to mean a radical constituted by amino acid linked to each other via amine bonds. It will be appreciated that the radical “a chain of 1-5 amino acids” is linked via the C-terminal when attached to an amine and via the N-terminal (or a side chain amino acid) when attached to a carbonyl.

When A is C—R the group Q is typically selected from hydrogen, carboxy, aminocarbonyl, mono- or di(C₁₋₂₄-alkyl)aminocarbonyl, (a chain of 1-5 amino acid(s))-carboxy; and, when A is N, the group Q is typically selected from hydrogen, carboxy-C₁₋₃-alkyl, aminocarbonyl-C₁₋₃-alkyl, mono- or di(C₁₋₂₄-alkyl)aminocarbonyl-C₁₋₃-alkyl; C₁₋₂₄-alkoxycarbonyl-C₁₋₃-alkyl, and (a chain of 1-5 amino acid(s))-carboxy-C₁₋₃-alkyl.

A subclass of applicable compounds within the formula Gₕ has the formula

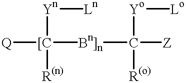

wherein each of Y⁰, . . . , Yⁿ independently is selected from —O—(CH₂)ₚ—C(═O)—NH—, —(CH₂)ₚ—C(═O)—NH—, —O—(CH₂)ₚ—NH—C(═O)—, —(CH₂)ₚ—NH—C(═O)—, —(CH₂)ₚ—, where p is 0-5; each of B¹, . . . , Bⁿ independently is selected from —(CH₂)_{q}—NH—C(═O)—(CH₂)ᵣ—, —(CH₂)_{q}—C(═O)—NH—(CH₂)r-, where q and r each independently are 0-6, such as 0-4, and the sum q+r is 0-6, such as 2-4; each of R⁽⁰⁾, . . . , R⁽ⁿ⁾ independently is selected from hydrogen and optionally substituted C₁₋₄-alkyl; Q is selected from hydrogen, carboxy, aminocarbonyl, mono- or di(C₁₋₆-alkyl)aminocarbonyl, and (a chain of 1-5 amino acids)-carbonyl; and Z is selected from side chains of the α-amino acids.

A more particular subclass is represented by compound of the formula

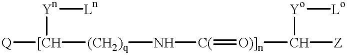

wherein q is 1-4 and n is 1-9, such as those where Q is selected from hydrogen and aminocarbonyl (H₂N—C(═O)—); Y⁰, . . . , Yⁿ are selected from —O—CH₂—C(═O)—NH— and —CH₂—C(═O)—NH—; Z is selected from hydrogen and methyl; and n is 1-4;

e.g. those where Q is aminocarbonyl (H₂N—C(═O)); Y⁰, . . . , Yⁿ are —O—CH₂—C(═O)—NH—; Z is selected from hydrogen and methyl,

such as those where n is 1; Q is aminocarbonyl (H₂N—C(═O)); Y⁰ is —O—CH₂—C(═O)—N>; Y¹ is —0—CH₂—C(═O)—NH—; Z is hydrogen or methyl.

Another more particular subclass is represented by compound of the formula

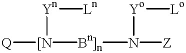

wherein each of Y⁰, . . . , Yⁿ independently is selected from —O—(CH₂)ₚ—C(═O)—, —(CH₂)ₚ—C(═O)—, —(CH₂)ₚ—NH—C(═O)—, and —O—(CH₂)ₚ—NH—C(═O)—, where p is 0-5; each of B¹-Bⁿ independently is selected from —(CH₂)_{q}—NH—C(═O)—(CH₂)ᵣ—, —(CH₂)_{q}—C(═O)—NH—(CH₂)ᵣ—, where q and r each are 0-4, and the sum q+r is 2-4, and where one of the hydrogen atoms of one or more of the methylene groups is/are optionally substituted with a group selected from side chains of α-amino acids; Q is selected from hydrogen, carboxy-C₁₋₃-alkyl, aminocarbonyl-C₁₋₃-alkyl, mono- or di(C₁₋₆-alkyl)aminocarbonyl-C₁₋₃-alkyl; and Z is selected from hydrogen, C₁₋₆-acylamino-C₁₋₄-alkyl;

such as compounds of the formula

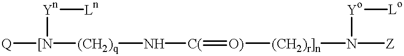

wherein q and r each are 1-3, and the sum q+r is 2-4.

Still another more particular subclass is represented by compound of the formula

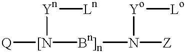

wherein each of Y⁰-Yⁿ independently is selected from —O—(CH₂)ₚ—C(═O)—, —(CH₂)ₚ—C(═O)—, —(CH₂)ₚ—NH—C(═O)—, —O—(CH₂)ₚ—NH—C(═O)—, where p is 0-5; each of B¹-Bⁿ independently is selected from —C(═O)—(CH₂)_{q}—NH—C(═O)—(CH₂)ᵣ—, —C(═O)—(CH₂)_{q}—C(═O)—NH—(CH₂)ᵣ—, —(CH₂)ₛ—, where q and r each are 0-3, and the sum q+r is 1-3, s is 2-6, and where one of the hydrogens of one or more of the methylene groups is/are optionally substituted with a group selected from side chains of α-amino acids; Q is selected from hydrogen, carboxy-C₁₋₃-alkyl, aminocarbonyl-C₁₋₃-alkyl, mono- or di(C₁₋₆-alkyl)aminocarbonyl-C₁₋₃-alkyl, and Z is selected from hydrogen, C₁₋₄-alkyl, C₁₋₆-acylamino-C₁₋₄-alkyl;

such as compounds of the formula

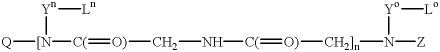

or compound of the formula

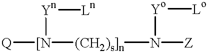

wherein s is 1-4, preferably 2 or 3.

It is believed that a number of compounds within the above formulae are uniquely novel and thereby constitute a separate aspect of the invention. Thus, the present invention also provides a compound of the formula X

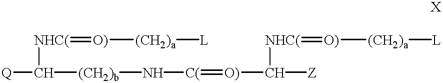

wherein

a is 0-2 and b is 1-5;

L is selected from the group consisting of N—(C₁₋₆-alkyl)-thymine, anthracene, acridizinium salts, and tetracene;

Q is selected from the group consisting of hydrogen, carboxy, aminocarbonyl, mono- or di(C₁₋₂₄-alkyl)aminocarbonyl, (a chain of 1-5 amino acid(s))-carboxy;

Z is selected from the group consisting of side chains of α-amino acids, hydrogen, methyl, cyanomethyl, ethyl, 1-propyl, 2-propyl, 2-methyl-1-propyl, 2-hydroxy-2-methyl-1-propyl, 1-butyl, 2-butyl, methylthioethyl, benzyl, p-amino-benzyl, p-iodo-benzyl, p-fluoro-benzyl, p-bromo-benzyl, p-chloro-benzyl, p-nitro-benzyl, 3-pyridylmethyl, 3,5-diiodo-4-hydroxy-benzyl, 3,5-dibromo4-hydroxy-benzyl, 3,5-dichloro-4-hydroxy-benzyl, 3,5-difluoro-4-hydroxy-benzyl, 4-methoxy-benzyl, 2-naphtylmethyl, 1-naphtylmethyl, 3-indolylmethyl, hydroxymethyl, 1-hydroxyethyl, mercaptomethyl, 2-mercapto-2-propyl, 4-hydroxybenzyl, aminocarbonylmethyl, 2-aminocarbonylethyl, carboxymethyl, 2-carboxyethyl, aminomethyl, 2-aminoethyl, 3-amino-propyl, 4-amino-1-butyl, 3-guanidino-1-propyl, 4-imidazolyl-methyl, C₁₋₂₄-alkyl, N-(C₁₋₂₄-acyl)-amino-(C₁₋₆-alkyl), and (a chain of 1-5 amino acid(s))-amino-(C₁₋₆-alkyl);

such as wherein

b is 24;

Q is selected from the group consisting of hydrogen, carboxy, aminocarbonyl, mono- or di(C₁₋₁₈-alkyl)aminocarbonyl, (a chain of 1-5 amino acid(s))-carboxy;

Z is selected from the group consisting of side chains of α-amino acids, hydrogen, methyl, cyanomethyl, ethyl, 1-propyl, 2-propyl, 2-methyl-1-propyl, 2-hydroxy-2-methyl-1-propyl, 1-butyl, 2-butyl, methylthioethyl, benzyl, p-amino-benzyl, p-iodo-benzyl, p-fluoro-benzyl, p-bromo-benzyl, p-chloro-benzyl, p-nitro-benzyl, 3-pyridylmethyl, 3,5-diiodo-4-hydroxy-benzyl, 3,5-dibromo-4-hydroxy-benzyl, 3,5-dichloro-4-hydroxy-benzyl, 3,5-difluoro-4-hydroxy-benzyl, 4-methoxy-benzyl, 2-naphtylmethyl, 1-naphtylmethyl, 3-indolylmethyl, hydroxymethyl, 1-hydroxyethyl, mercaptomethyl, 2-mercapto-2-propyl, 4-hydroxybenzyl, aminocarbonylmethyl, 2-aminocarbonylethyl, carboxymethyl, 2-carboxyethyl, aminomethyl, 2-aminoethyl, 3-amino-propyl, 4-amino-1-butyl, 3-guanidino-1-propyl, 4-imidazolylmethyl, C-₁₋₁₈-alkyl, N—(C₁₋₁₈-acyl)-amino-(C₁₋₆-alkyl), and (a chain of 1-5 amino acid(s))-amino-(C₁₋₆-alkyl);

e.g. wherein

Q is selected from the group consisting of hydrogen, carboxy, aminocarbonyl, mono- or di(C₁₋₁₂-alkyl)aminocarbonyl, (a chain of 1-5 amino acid(s))-carboxy;

Z is selected from the group consisting of side chains of α-amino acids, hydrogen, methyl, cyanomethyl, ethyl, 1-propyl, 2-propyl, 2-methyl-1-propyl, 2-hydroxy-2-methyl-1-propyl, 1-butyl, 2-butyl, methylthioethyl, benzyl, p-amino-benzyl, p-iodo-benzyl, p-fluoro-benzyl, p-bromo-benzyl, p-chloro-benzyl, p-nitro-benzyl, 3-pyridylmethyl, 3,5-diiodo-4-hydroxy-benzyl, 3,5-dibromo-4-hydroxy-benzyl, 3,5-dichloro-4-hydroxy-benzyl, 3,5-difluoro-4-hydroxy-benzyl, 4-methoxy-benzyl, 2-naphtylmethyl, 1-naphtylmethyl, 3-indolylmethyl, hydroxymethyl, 1-hydroxyethyl, mercaptomethyl, 2-mercapto-2-propyl, 4-hydroxybenzyl, aminocarbonylmethyl, 2-aminocarbonylethyl, carboxymethyl, 2-carboxyethyl, aminomethyl, 2-aminoethyl, 3-amino-propyl, 4-amino-1-butyl, 3-guanidino-1-propyl, 4-imidazolylmethyl, C₁₋₁₂-alkyl, N-(C₁₋₁₂-acyl)-amino-(C₁₋₆-alkyl), and (a chain of 1-5 amino acid(s))-amino-(C₁₋₆-alkyl).

Also interesting are those wherein b is 3, and those wherein Q is aminocarbonyl and Z is hydrogen or the side chain of an α-amino acids such as hydrogen or methyl.

The present invention further provides a compound of the formula

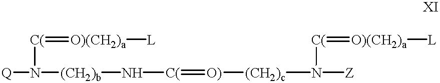

wherein

a is 0-2, b is 1-3 and c is 1-3;

L is selected from the group consisting of N—(C₁₋₆-alkyl)-thymine, anthracene, an acridizinium salt, and tetracene;

Q is selected from the group consisting of hydrogen, carboxy-C₁₋₃-alkyl, aminocarbonyl-C₁₋₃-alkyl, mono- or di(C₁₋₂₄-alkyl)aminocarbonyl-C₁₋₃-alkyl; C₁₋₂₄-alkoxycarbonyl-C₁₋₃-alkyl, and (a chain of 1-5 amino acid(s))-carboxy-C₁₋₃-alkyl;

Z is selected from the group consisting of hydrogen, amino-C₁₋₄-alkyl, N-mono- or di(C₁₋₂₄-alkyl)-amino-C₁₋₄-alkyl, C₁₋₂₄-acylamino-C₁₋₄-alkyl, and (a chain of 1-5 amino acids)-amino-C₁₋₄-alkyl; or

wherein

Q is selected from the group consisting of hydrogen, carboxy-C₁₋₂-alkyl, aminocarbonyl-C₁₋₂-alkyl, mono- or di(C₁₋₁₈-alkyl)aminocarbonyl-C₁₋₂-alkyl; C₁₋₁₈-alkoxycarbonyl-C₁₋₂-alkyl, and (a chain of 1-5 amino acid(s))-carboxy- C₁₋₂-alkyl; p1 Z is selected from the group consisting of hydrogen, amino-C₁₋₃-alkyl, N-mono- or di(C₁₋₁₈-alkyl)-amino-C₁₋₃-alkyl, C₁₋₁₈-acylamino-C₁₋₃-alkyl, and (a chain of 1-5 amino acids)-amino-C₁₋₃-alkyl; or

wherein

Q is selected from the group consisting of hydrogen, carboxy-CH₂, aminocarbonyl-CH₂, mono- or di(C₁₋₁₂-alkyl)aminocarbonyl-CH₂, C₁₋₁₂-alkoxycarbonyl-CH₂, and (a chain of 1-5 amino acid(s))-carboxy-CH₂;

Z is selected from the group consisting of hydrogen, amino-(CH₂)₂, N-mono- or di(C₁₋₁₂-alkyl)-amino-(CH₂)₂, C₁₋₁₈-acylamino-(CH₂)₂, and (a chain of 1-5 amino acids)-amino-(CH₂)₂.

Also interesting are those wherein b is 2-3 and c is 1-2, and those wherein b is 2 and c is 1, and those wherein Q is H₂NC(═O)CH₂ and Z is H₂NCH₂C(═O)NH(CH₂)₂.

The present invention also provides materials comprising the compounds described herein, in particular materials comprising compounds of the formula X or XI defined above. The present invention also provides an optical storage medium comprising a compound of the formula X or XI defined above and a substrate. The substrate is typically glass, quartz, polycarbonate, polyolefins, etc.

### Synthesis of Peptide-Based OPTIDES

An advantage of the present invention is that the compounds which are especially suitable for optical applications, can be synthesised by using conventional peptide chemistry techniques such as solution phase peptide synthesis and solid phase peptide synthesis. An advantage of the standard solid phase peptide strategy is that it permits stepwise assembly of monodisperse and chemically unambiguous peptides by Merrifield solid-phase synthesis.

When used about a compound, the term “monodisperse” is intended to mean that the molecules of the compound in question are identical. It is understood that “monodisperse” is a theoretical term which in reality, and within in the present context, means that the compounds are as pure as it is possible within the technology used, e.g. the solid phase peptide chemistry technology, thus, monodisperse compounds may comprise small traces of impurities so that the purity of the compounds are at least 98% pure, preferably 99% pure, in particular 99.9% pure.

The synthesis of OPTIDES based on diamino acid Nα-substituted oligopeptides involves three levels of protection employing tert-butyloxycarbonyl (Boc) as a weak acid-labile δ-amino protecting group, 9-fluorenylmethyloxycarbonyl (Fmoc) as a weak base-labile α-amino protecting group, and 4-methylbenzhydrylamine (MBHA) as a strong acid-labile anchoring linkage to the solid support. Each cycle of the solid-phase assembly consists of two individual coupling steps. The first step introduces the backbone unit and the second step incorporates the side-chain unit.

The principle of anchoring molecules onto a solid matrix, which helps in “keeping track” of the intermediate products during chemical transformations, is known as Solid-Phase Synthesis or Merrifield Synthesis. Established methods for the stepwise or fragment-wise solid-phase assembly of amino acids into peptides normally employ a beaded matrix of slightly cross-linked styrene-divinylbenzene copolymer, the cross-linked copolymer having been formed by the pearl polymerisation of styrene monomer to which has been added a mixture of divinylbenzenes. A level of 1-2% cross-linking is usually employed. Such a matrix also applies to solid-phase OPTIDE synthesis in the context of the present invention.

Concerning the initial functionalisation of the solid phase, more than fifty methods have been described in connection with traditional solid-phase peptide synthesis [see Barany & Merrifield in “The Peptides” Vol. 2, Academic Press, New York, 1979, pp. 1-284, and Stewart & Young, “Solid Phase Peptide Synthesis”, 2nd Ed., Pierce Chemical Company, Illinois, 1984], of which reactions for the introduction of chloromethyl (Merrifield resin; via a chloromethyl methyl ether/SnCl₄ reaction), aminomethyl (via a N-hydroxymethyl-phthalimide reaction are the most widely applied. Regardless of its nature, the purpose of the functionality is normally to form an anchoring linkage between the copolymer solid support and the C-terminal of the first amino acid which it is desired to couple to the solid support. It is generally convenient to express the “concentration” of a functional group in terms of mmol/g. Other reactive functionalities which have been initially introduced include 4-methylbenzhydrylamino and 4-methoxybenzhydrylamino. All of these established methods are in principle useful within the context of the present invention. Preferred embodiments of OPTIDE synthesis methods within the context of the present invention employ aminomethyl as the initial functionality, in that aminomethyl is particularly advantageous with respect to the incorporation of “spacer” or “handles” groups owing to the reactivity of the amino group of the aminomethyl functionality with respect to the essentially quantitative formation of amide bonds to a carboxylic acid group at one end of the spacer-forming reagent. A vast number of relevant spacer- or handle-forming bifunctional reagents have been described [see Barany et al. lnt. J. Peptide Protein Res. 30, 705 (1987)], especially reagents which are reactive towards amino groups, such as the amino group in the aminomethyl function, including a 4-(haloalkyl)aryl-lower alkanoic acid such as 4-(bromomethyl)phenylacetic acid, a Boc-aminoacyl-4-(oxymethyl)aryl-lower alkanoic acid such as Boc-aminoacyl-4-(oxymethyl)phenylacetic acid, N-Boc-p-acylbenzhydrylamine such as N-Boc-p-glutaroylbenzhydrylamine, N-Boc-4′-lower alkyl-p-acylbenzhydrylamine such as N-Boc-4′-methyl-p-glutaroylbenzhydrylamine, N-Boc4′-lower alkoxy-p-acylbenzhydrylamine such as N-Boc-4′-methoxy-p-glutaroylbenzhydrylamine and 4-hydroxymethylphenoxyacetic acid. One type of spacer group relevant within the context of the present invention is the phenylacetamidomethyl (Pam) handle, which, deriving from the electron withdrawing effect of the 4-phenylacetamidomethyl group, is ca. 100 times more stable than the classical benzyl ester linkage towards the Boc-amino deprotection reagent trifluoroacetic acid (TFA).

Certain functionalities of particular relevance within the context of the present invention are those based on benzhydrylamino and derivatives thereof, including 4-methylbenzhydrylamino and 4-methoxybenzhydrylamino, which may be incorporated for the purpose of cleavage of a synthesised OPTIDE chain from the solid support such that the C-terminal of the OPTIDE chain is in amide form.

An alternative strategy concerning the introduction of spacer or handle groups is the so-called “preformed handle” strategy [see Tam et al. Synthesis 955-57 (1979)], which offers complete control over coupling of the first amino acid, and excludes the possibility of complications arising from the presence of undesired functional groups not related to the peptide or OPTIDE synthesis. Other useful anchoring schemes include the “multi-detachable” resins [Tam et al., Tetrahedron Lett. 4935 (1979) and J. Am. Chem. Soc. 102, 6117 (1980); Tam, J. Org. Chem. 50, 5291 (1985)], which provide more than one mode of release and thereby allow more flexibility in synthetic design.

Suitable choices for N-protection of the δ-amino group (or any other backbone amino group through which the oligomerisation takes place) are the tert-butyloxycarbonyl (Boc) group, normally in combination the 9-fluorenylmethyloxycarbonyl (Fmoc) group for N-protection of the α-amino group (or any other pendant or backbone amino group through which the side chain is to be attached), or vice versa, although a number of other possibilities exist which are well known in conventional solid-phase peptide synthesis, such as protection combinations further including tert-butyl- or benzyl-based groups. Thus, a wide range of other useful amino protecting groups exist, some of which are Adoc (2-adamantyloxycarbonyl), Bpoc (2-(p-biphenyl)-2-propyloxycarbonyl), Mcb (1-methylcyclobutyl), Bic (5-benzisoxazolylmethylenoxycarbonyl), the o-nitrophenyl sulfenyl (Nps), and the dithiasuccinoyl (Dts). In addition to these amino protecting groups and in particular those based on the widely used urethane functionality which successfully prohibits racemisation (mediated by tautomerisation of the readily formed oxazolinone (azlactone) intermediates) during the coupling of most α-amino acids, clearly a whole range of nonurethane-type of amino protecting groups are applicable when assembling OPTIDE molecules. Finally, whether the overall strategy for chemically assembling OPTIDE molecules relies on for example differential acid stability of amino and side-chain protecting or employs an orthogonal, i.e. chemoselective, protection scheme, the choice of side-chain protecting groups, in general, depends on the choice of the amino protecting group, since the protection of side-chain functionalities must withstand the conditions of the repeated amino deprotection cycles.

Based on the recognition that most operations are identical in the synthetic cycles of solid-phase peptide synthesis (as is also the case for solid-phase OPTIDE synthesis), a new matrix, long-chain polystyrene-grafted polyethylene film (PEPS), has been reported [Berg et al., J. Am. Chem. Soc. 111, 8024 (1989)] aiming at facilitating and speeding up the preparation of large numbers of peptides. It is reasoned that the PEPS film support, comprising linker or spacer groups adapted to the particular chemistry in question, should be valuable in the synthesis of multiple OPTIDE molecules. Two other methods proposed for the simultaneous synthesis of large numbers of peptides should apply as well to the preparation of multiple OPTIDE molecules: The first of these methods utilises acrylic acid-grafted polyethylene-rod-and-96-microtiter wells to immobilise the growing peptide chains and to perform the compartmentalised synthesis, and the second method utilises a “tea bag” containing the traditionally used polymer beads to compartmentalise the synthesis. Other relevant proposals for multiple peptide or OPTIDE synthesis in the context of the present invention include the simultaneous use of two different supports with different densities, combining of reaction vessels via a manifold, multicolumn solid-phase synthesis, the use of cellulose paper, the “portion-mixing” and library methods. Also, another library method can be used, namely, the recently reported “light-directed, spatially addressable, parallel chemical synthesis” technology [Fodor et al., Science 251, 767 (1991)], a technique that combines solid-phase chemistry and photolithography to produce thousands of highly diverse, but identifiable, permanently immobilised compounds (such as peptides) in a substantially simultaneous way.

While the conventional cross-linked styrene/divinylbenzene copolymer and other polystyrene-based matrices are the presently preferred in the context of solid-phase OPTIDE synthesis, a non-limiting list of examples of solid supports, fashioned and compartmentalised in any suitable form, which may be of relevance are: (1) Particles based upon copolymers of dimethylacrylamide cross-linked with N,N′-bisacryloylethylene-diamine, including a known amount of N-tert-butoxycarbonyl-β-alanyl-N′-acryloylhexamethylenediamine. Several spacer molecules are typically added via the β-alanyl group, followed thereafter by the amino acid residue subunits. Also, the β-alanyl-containing monomer can be replaced with an acryloyl sarcosine monomer during polymerisation to form resin beads. The polymerisation is followed by reaction of the beads with ethylenediamine to form resin particles that contain primary amines as the covalently linked functionality.

Of relevance within the context of the present invention is also the so-called PEGA resin consisting of a beaded polyethyleneglycol polyacrylamide co-polymer. The polyacrylamide-based supports are relatively more hydrophilic than are the polystyrene-based supports and are usually used with polar aprotic solvents including dimethylformamide, dimethylacetamide, N-methylpyrrolidone and the like; (2) a second group of solid supports is based on silica-containing particles such as porous glass beads and silica gel. One example is the reaction product of trichloro-[3-(4-chloromethylphenyl]propylsilane and porous glass beads sold under the trademark PORASIL E by Waters Associates, Framingham, Mass. Similarly, a mono ester of 1,4-dihydroxymethylbenzene and silica (sold under the trademark BIOPAK by Waters Associates) has been reported to be useful; (3) a third general type of useful solid support may be termed composites in that they are constituted by two major ingredients, a resin and another material that is also substantially inert to the organic synthesis reaction conditions employed. One exemplary composite utilised glass particles coated with hydrophobic, polymerised, cross-linked styrene containing reactive chloro methyl groups and was supplied by Northgate Laboratories, Inc., Hamden, Conn. Another exemplary composite contains a core of fluorinated ethylene polymer onto which is grafted polystyrene. Finally, (4) contiguous solid supports other than PEPS, such as cotton sheets and hydroxypropylacrylate coated polypropylene membranes, are suited for OPTIDE synthesis as well.

Whether manually or automatically operated, solid-phase OPTIDE synthesis in the context of the present invention is normally performed batchwise. However, most of the syntheses are equally well carried out in the continuous-flow mode, where the support is packed into columns. With respect to continuous-flow solid-phase synthesis the rigid poly(dimethyl acrylamide)-Kieselguhr support appears to be particularly successful, but another valuable configuration concerns the one worked out for the standard copoly(styrene-1%-divinylbenzene) support.

While the solid-phase technique is the presently preferred in the context of OPTIDE synthesis, other methodologies or combinations thereof, for example in combination with the solid-phase technique, apply as well: (1) Clearly, the classical solution-phase methods for peptide synthesis [e.g. Bodanszky, “Principles of Peptide Synthesis”, Springer-Verlag, Berlin-New York (1984)], either by stepwise assembly or by segment/fragment condensation, are of particular relevance when considering especially large scale productions (grams, kilograms, and even tons) of OPTIDE compounds; (2) also, the so-called “liquid-phase” strategy, which utilises soluble polymeric supports such as linear polystyrene and polyethylene glycol (PEG), is useful; (3) random polymerisation yielding mixtures of many molecular weights (“polydisperse”) peptide or OPTIDE molecules could be relevant for purposes preparation of thicker films; (4) a technique based on the use of polymer-supported amino acid active esters, some times referred to as “inverse Merrifield synthesis” or “polymeric reagent synthesis”, offers the advantage of isolation and purification of intermediate products, and may thus provide a particularly suitable method for the synthesis of medium-sized, optionally protected, OPTIDE molecules, that can subsequently be used for fragment condensation into larger OPTIDE molecules; (5) it is envisaged that OPTIDE molecules may be assembled enzymatically by enzymes such as proteases or derivatives thereof with novel specificities (obtained for example by artificial means such as protein engineering). Also, one can envision the development of “OPTIDE ligases” (much effort is currently directed towards the development of “peptide ligases”) for the condensation of a number of OPTIDE fragments into very large OPTIDE molecules; (6) since antibodies can be generated to virtually any molecule of interest, the recently developed catalytic antibodies (abzymes), discovered simultaneously by the groups of Lerner, should also be considered as potential candidates for assembling OPTIDE molecules. Thus, there has been considerable success in producing so-called abzymes catalysing acyl-transfer reactions. Finally, completely artificial enzymes, recently pioneered by Stewart's group, may be developed to suit OPTIDE synthesis. In conclusion, no single strategy may be wholly suitable for the synthesis of a specific OPTIDE molecule, and therefore, sometimes a combination of methods may work best, as will be appreciated by the person skilled in the art.

### Preparation of Materials Comprising the Peptides

The material is prepared in such a way that substantially all cycloaddition reactions are between two chromophores within the same molecule. In order to prepare thick films (10-1000 μm), it is possible to incorporate the compound into a polymeric substrate. By this “dilution” in a polymeric substrate, the cycloaddition reactions between two chromophores within the same molecule can be favoured. This being said, it is also interesting that the compound constitutes at least 80%, such as at least 90%, in particular at least 95%, of the material, or that the material essentially consists of the compound. The material may also comprise two or more types of the compounds defined above.

The material typically has a film thickness in a range of from 0.5 μm to 1000 μm, such as from 0.5 μm to 100 μm, e.g. from 1 to 10 μm, about 5 μm, and can be applied by allowing a solution of the compound, optionally in admixture with a polymer material, to dry out on the surface of a substrate holding the material. Also, and very applicable for industrial purposes, the compounds may be spin-coated onto a substrate.

In order to prepare a film of the material, a suitable quantity of the material is weighed such as 25 mg, and is dissolved in a solvent, or a mixture of solvents. The solvents can be, for example, hexafluoroisopropanol, methylene chloride or trifluoroacetic acid. One interesting advantage is that the compounds can be made water soluble, whereby the solvent to be used in the preparation process can be environmentally very friendly. The solution is filtered, e.g., through a syringe filter and cast on to a substrate. The substrate is usually made of glass, quartz, polycarbonate, polyolefins, etc. In special cases where ultraviolet transmittance is required, quartz substrates may be used. If it is desired to make a CD, then the substrate material can be plastic such as polycarbonate. Other suitable substrates can be made of cyclic olefins, such as Mylar.

### Use of the Peptides in Optical Storage

The invention resides in the novel understanding that materials comprising dimers or oligomers of compounds comprising a chromophore in each monomeric segment, will undergo an optical change upon irradiation at a first wavelength with a first intensity.

The information, or a part thereof, can be extracted from the material by measuring the reflection, refraction, transmission or diffraction of said irradiation of the second wavelength by the material in that the change in refractive index of the localised areas compared with the native (non-dimerised) areas of the material corresponds to the information. This has been accomplished as described in the examples. As will be understood, the material will most often be moved relative to the light source so that the surface (a predetermined area) of the material can be scanned. As in conventional processes.

The present invention relates to the method of use of the materials comprising the compound described herein for optical storage, such as digital (bit) and holographic storage. The compounds are preferably used in a material in the form of a film. For an overview of the technique possibilities for optical storage of information in materials, see WO 96/38410. As an example can be mentioned irradiation of a material with ultraviolet light, which causes a dimerisation of the chromophores, thereby changing the refractive index of the material.

One way of recording of information is to irradiate the material comprising chromophores with light at appropriate first wavelength with a first intensity. A laser beam can be focussed by means of appropriate optics on to the material. The chromophores thereby undergo a cycloaddition process and form dimers. The absorption of the dimers at the irradiated wavelength is much smaller than that of the chromophores. This will also result in a change in the refractive index at the irradiated areas. Thus bits can be written in the material corresponding to the photodimerised areas.

In order to read-out the information, one can reduce the intensity of the writing light, i.e. using a second wavelength corresponding to the first wavelength, but with a second intensity which is lower than the first intensity. This is done in order not to unintentionally photodimerise other areas. Maximum storage density would be achieved without a loss of signal to noise ratio, when the readout (second) wavelength is the same as writing (first) wavelength. If the material exhibits a threshold for the formation of dimers, this would be ideal for the read-out process. In this case, the second intensity should typically be less than 1/10, such as 1/50 or even less than 1/100 such as 1/1000 of the first intensity. It is believed that it is possible to achieve a very large number of read cycles such as 1,000,000 without causing considerable photodimerisation in the other areas.

Alternatively, a different wavelength may be used for the read-out (second wavelength). This wavelength can lie outside the absorption band of the dimers. One can also use the refractive index change for the read-out. Thus, bits recorded in the ultraviolet can be read with a red laser beam. In this case, no decrease in the signal to noise ratio would appear even after several read cycles.

Since the optical storage medium is suited for almost all types of information, it will be preferred to be able to use less power-consuming and compact light emitters such as light diodes, laser diodes, lamps, or low power gas lasers. The wavelength of these light emitters is at present between 100 and 1600 nm having a power of several milliwatts to watts.

The compound is preferably one whose chromophores are capable of being permanently or substantially permanently converted into dimers by irradiation with light of a single wavelength in the range 100-1600 nm. In this case, the photodimers are very stable at room temperature. However, the dimers can be converted to monomers by irradiation either at shorter or longer wavelengths depending on the Optide architecture.

In order to obtain convenient writing of information, it is preferred that the irradiation is performed with light between 200 and 700 nm with an energy between 1 mJ/cm² and 10 J/cm² for a period of time of at the most 1000 s, more specifically the irradiation is performed with light at 220-600 nm with an energy between 50 mJ/cm² and 5 J/cm² for a period of at the most 1000 s, or more specifically that the irradiation is performed with light at 250-515 nm, such as 266 nm emitted by a frequency quadrupled YAG laser or 350 nm, as emitted by a krypton laser with an energy of 2 J/cm² for a period of time at the most 400 s, such as at the most 300 s. In the compound according to the present invention, storage of information can be facilitated within even shorter irradiation-periods, e.g., at the most 100 s, such as at the most 30 s, or at the most 10 s, or even less than 5 s, such as less than 1 s.

In one embodiment, for ease of writing with the available laser sources, it is preferred that the chromophores of the compound be capable of being permanently or substantially permanently converted into dimers by irradiation with light of a single wavelength in the range of 100-1600 nm, such as in the range of 200-600 nm, preferably in the range of 220-500 nm, such as in the range of 250-360 nm, e.g. 266 nm from a frequency quadrupled YAG laser or 350 nm, as emitted by an krypton ion laser.

Naturally, all of the types of light sources emitting light in the above range, such as excimer lasers, frequency doubled YAG lasers, Kr lasers, diode lasers and synchrotron sources may be used for the purpose of writing information in the compound. Well-known examples of laser wavelengths are 266 nm from a frequency quadrupled YAG laser, 360, 488, and 515 nm from argon ion lasers, 350, 403, 407, 578, and 647 nm from krypton lasers, 1064, 532, and 266 nm from YAG lasers, 633 nm from He—Ne lasers, 780, 850, 1320, and 1550 nm from diode lasers. Also useful for storing the information digitally as bits are a focussed laser beam, an Hg lamp, etc., optionally by means of near field storage techniques.

This type of information is typically stored over at least a large part of the surface of a material, e.g. in the form of a film. Binary information may be stored, e.g., as bits by a focused laser. In this case, the storage density depends on the size of the bits. It has been shown that the size of bits is given by λ/NA, where λ is the wavelength of the laser and NA is the numerical aperture of the optics used to focus the laser beam. Bit sizes of 266 nm can be achieved, when the laser wavelength is 266 nm and the numerical aperture of the optics is 1. This will give a storage capacity of approximately 20 Gbytes on a single side on CD-ROM form factor. The term “localised area” refers to the fact that the information, or rather a piece of information, is stored in the material by irradiating an area of the material corresponding to the desired bit size. The desired bit size may very well be larger than the theoretical minimum bit size (see above), e.g. 10 times or larger. Due to nonlinear optical effects in the material, the desired bit size may even be smaller than the theoretical minimum bit size.

In order to facilitate storage of information using low energy light sources, which is desirable if the storage is to be performed by domestic users, it is preferred that storage of information is obtained by applying light to the compound at an energy between 1 mJ/cm² and 10 J/cm², when the compound is in the form of or incorporated into a thin film of a thickness in a range of from 0.5 μm to 1000 μm. It is specifically preferred that the light is applied to the compound at an energy between 50 mJ/cm² and 5 J/cm² when the compound is in the form of or incorporated into a film of a thickness in a range of from 0.5 μm to 100 μm.

To enable storage of information using safe light sources, it is preferred that the light is applied to the film at an energy between 100 mJ/cm² and 5 J/cm² when the compound is in the form of a film of thickness in a range of from 1 to 10 μm, such as light at an energy of about 2 J/cm² when the compound is in the form of a film with thickness of about 5 μm.

Generally, it is preferred that the photodimerisation is accompanied by a change in the refractive index of the material. In this case, the major part of the incident light is transmitted through the material, thereby increasing the signal-to-noise ratio of the detection of information.

Typically, the change in refractive index is at least 0.1%, such as at least 0.5%, preferably at least 1%, such as at least 5%, preferably at least 10%, such as at least 30% of the refractive index of the compound in the isotropic state. Large modulations of the refractive index, in general, lead to a better signal-to-noise ratio in the detection of information.

One way of erasing the information in the material is to apply a beam of light with a different wavelength (second wavelength) than the wavelength used for writing (first wavelength). In all cases of photodimerisation, the dimers can be broken back into monomers by light of a shorter wavelength. It is convenient and preferred to irradiate the compound with monochromatic light, such as coherent light, especially laser light.

The information may also be a set of information in analogue form, i.e. non-digital form, e.g. in the form of a surface relief or a hologram. However typically, the the stored information is digital. Combinations of analogue and digital information may also be stored in the same material.

Another way of recording information in the material is by means of holography. In this case, the incident laser beam is split into two parts by means of a beam splitter. One of the beams called the reference beam impinges directly on the film. The other beam called the object beam, passes through the object that needs to be stored and also impinges on the film. The experimental set-up is so adjusted that the two beams fall exactly at the same spot on the film, creating interference fringes which are characteristic of the object. For reconstruction, the irradiated spot is illuminated by light of either the same or different wavelength in a manner conjugate to that of the reference beam. The object will then be recreated. For holographic recording using dimerisation, this might provide a good alternative.

When the holograms are read out at a wavelength where the dimers do not absorb, we have a phase hologram and the diffraction efficiency can be much higher.

In one embodiment, first and second specific wavelengths are substantially the same, however, the first intensity is at least 2 times, such as 5 times, e.g. 10 times, higher than the second intensity.

Alternatively, the first wavelength and the second wavelength differ by at least 10 nm, such as at least 25 nm.

In another embodiment, the material is irradiated with polarised light of a first wavelength in the range of 100-1600 nm, and said compound is simultaneously or subsequently irradiated with polarised light of a second wavelength in the range of 100-1600 nm.

In another embodiment, the irradiation with the first and second wavelength is carried out with linearly or circularly polarised coherent light, said wavelengths being in the range of 300-700 nm.

The method may further comprise the later step of irradiation of the material, localised areas thereof, at third wavelength thereby inducing a photodissociation thereby reforming the two chromophores. By this procedure, information is erased from the material and the material can afterwards undergo a new cycle of writing and reading-out. The stored information may be erased by means of irradiation with a wavelength of 100-1600 nm as the case may be.

The irradiation of the material with light changes the absorption or refractive index of the material. Changes in absorption are always accompanied by changes in the refractive index. Changes in absorption and refractive index are related through the Kramers-Kronig relations.

The irradiation of the material with light may change the frequency or the polarisation of the light emerging from the material. This may be the case for tetracene and pentacene chromophores as the fluorescence wavelength is different from the exciting wavelength. The fluorescence of the monomers can be quenched through the formation of the photodimers. Fluorescent detection is much more sensitive than a detection of changes in absorption.

It is believed that the material should be exposed to quite high temperatures before the cycloadduct undergoes dissociation, thus, it is believed that the stored information in the material can withstand (is not erased) hot storing at 100° C. for several weeks.

The material obtained may also be used in microlithography. Alternative uses of the material are in the fabrication of waveguides for application in the ultraviolet, visible or infrared range (see also further below).

In view of the above description and the claims, it should of course be understood that the present invention also applicable in the instances where the compounds of the material are fully or partially (i.e. homogeneously throughout the material) dimerised, and where the storing of information in the material is performed by irradiating localised areas of the material at a third wavelength with a third intensity thereby inducing a photodissociation of cycloadducts present in the material. Read-out may then be accomplished by irradiation at a second wavelength with a second intensity. The specifications and guidelines given above, will of course apply for this situation, mutatis mutandis. Thus, the method may in this instance include a preceding step were a substantial area of the material is irradiated at a first wavelength with a first intensity thereby inducing a cycloaddition between chromophores in said material whereby cycloadducts are formed in said substantial area.

### Use of the Peptides as Optical Waveguides

The present invention further relates to the method of use of the peptides to fabricate optical waveguides or part of optical waveguides and related systems. Such waveguides may comprise two or more channels through which optical transmission can be achieved. The waveguides can be fabricated by spin-coating a layer of the peptide material on a clear substrate such as glass or semiconducting or conducting substrate such as silicon. The transmission channels can be formed through irradiation of the peptide films at the wavelength for dimerisation. The refractive index will be higher in the irradiated area, and thus will be able to guide light. The waveguides are suitable for use in the visible, near-IR, IR, or UV ranges. The waveguide can be used for optical communication and optical interconnection systems as well as related light-transmission applications and systems. The photodimerisation of quinones has been known for more than a century and some anthracene diquinones in the nondimerised form are known to exhibit an intense absorption band in the near-IR region, e. g., at 1560 nm. Thus, peptides (and other types of compounds described herein) that contain anthracene diquinone side chains would provide one option for providing materials that can be modulated for use in waveguides. It may be possible to achieve optical switching between the waveguides through an application of electric or electromagnetic fields.

### Use of the Peptides as Materials for Digital Storage of Information in the Ultraviolet

The present invention further relates to the method of use of the peptides as storage media for digital information with ultraviolet light. Such media may comprise of a peptide material spin-coated on to a glass or plastic disk. Suitable reflective layers as well as protective layers can be provided. The films are then irradiated with light in the ultraviolet range such as at 266 nm from a suitable laser. This light is focussed onto the peptide film by means of a high numerical aperture lens. A “bit” is then fabricated in this process. Because of the short wavelength and high numerical aperture involved in the storage process, several gigabytes of information can be stored on a disk of the same size as a compact digital disk. Using an appropriate chromophore such as acridizinium or benzacridizinium it is possible to shift the wavelength at which information is stored to the blue region of the spectrum. Compact blue laser diodes are now commercially available. Thus optical storage in the form of digital (bit) storage or holographic storage can be accomplished through photodimerization in the Optides in the wavelength range 350-500 nm.

### Fabrication of Surface Relief Features in the Optides

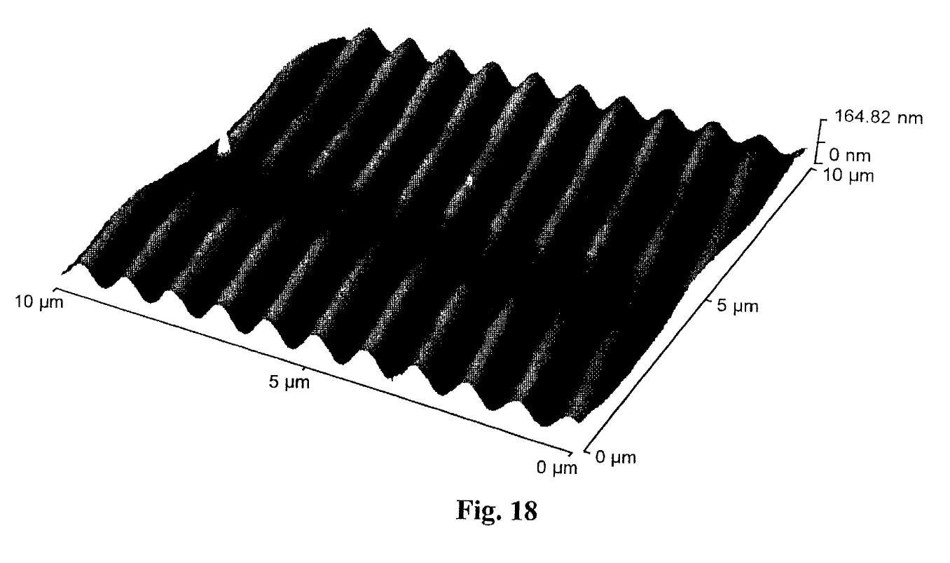

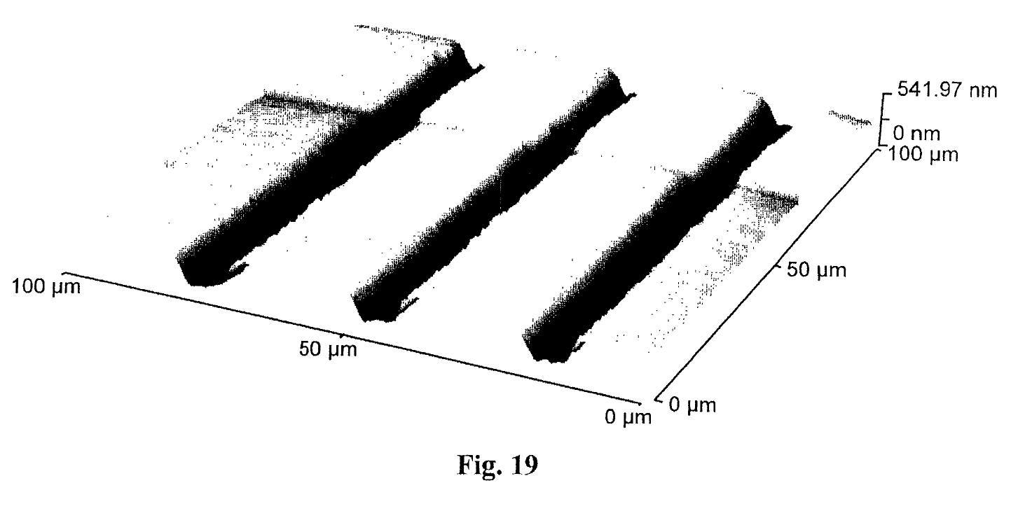

The present invention further relates to the method of producing surface indentations when the material is irradiated with UV or blue light. It has been observed that “holes” are created when an Optide film is irradiated with light. (see FIGS. 18 and 19). A decrease in the volume of the material due to the dimerisation process is thought to be the cause. This effect can be utilised in the manufacture of master CD's. The media in this case comprise of an Optide material spin-coated on to a glass disc. “Bits” are recorded in the usual fashion by irradiating the film with focussed light from a laser. This film is then overcoated with a material such as Nickel, which forms the master, from which a stamper can be made. This allows an easy replication process with very high data capacity through injection molding. This may find applications in areas such as Digital Cinema.

### EXAMPLES

### Example 1

### Preparation of dno-716

(a) Solid-Phase Synthesis Procedure for the Preparation of dno-716

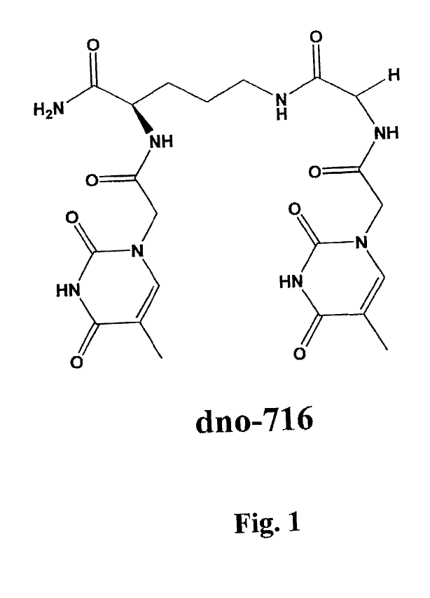

OPTIDE dimer dno-716 (c.f., FIG. 1) was synthesised by a modified stepwise Merrifield method using three different monomer subunits. The first one was the commercially available protected backbone monomer N^{α}-Fmoc-L-Orn(N^{δ}-Boc)-OH (Bachem-Switzerland). The second one was the commercially available side-chain monomer thymine-1-acetic acid (Aldrich). Furthermore, the commercially available Boc-Gly-OH (Bachem-Switzerland) was used to incorporate glycine as the N-terminal backbone unit. To obtain a C-terminal amide, the dimer was assembled on a p-methylbenzhydrylamine (MBHA) 1% divinylbenzene cross-linked polystyrene resin (Peninsula, England) (100-200 mesh) initially loaded with 0.42 mmol amino groups per gram resin. Activation by Castro's reagent (BOP) (Richelieu, Canada) allowed efficient incorporation of both backbone and side-chain residues when the couplings were performed in methylene chloride with a monomer concentration of 0.10 M and a BOP concentration of 0.10 M in combination with 0.20 M diisopropylethylamine (DIEA). The alternating deprotections of N^{α}-Fmoc and N^{δ}-Boc groups were accomplished with 20% (v/v) piperidine in N,N-dimethylformamide and 5% (v/v) m-cresol in trifluoroacetic acid (TFA) in methylene chloride, respectively. A detailed synthetic protocol is described below in (b). The progress of the OPTIDE synthesis was monitored throughout by a ninhydrin reaction [Sarin, V. K., Kent, S. B. H., Tam, J. P. & Merrifield, R. B. Anal. Biochem. 117, 147-157 (1981)], which indicated that the single coupling (>60 min) of each backbone as well as each side-chain residue proceeded with an efficiency of >99%. Cleavage of the free dno-716, Gly-(T)-L-Orn(N^{α}-T)-NH₂, from the resin was accomplished with neat anhydrous HF at 0° C. for 1 h. The compound was extracted from the resin with 50% (v/v) trifluoroacetic acid in methylene chloride and was obtained as a reddish/brown after evaporation of the solvents. 0.5 gram of starting resin gave approximately 110 mg of the product. Molecular weight (M+H⁺): 521.5.

(b) Synthetic Protocol

Synthesis was performed manually in a standard solid-phase peptide synthesis reaction vessel (Merrifield, R. B. et al., Biochemistry, vol. 21, pp 5020-5031 (1982)).The following coupling protocol was used to incorporate the monomer in question: A solution of 0.1 M monomer and 0.1 M BOP and 0.2 M DIEA was prepared and left for 2 min before it, in the coupling step in question, was added to the resin. Coupling time was one hour or more. After coupling of the monomer, the resin was washed sequentially with DMF (2×2 min) and methylene chloride (2×2 min). The following protocol was used to deprotect the Fmoc group. 20% piperidine in DMF (1×30 min), DMF (1×2 min), methylene chloride (1×2 min), 5% diisopropylethylamine in methylene chloride (1×2 min), methylene chloride (1×2 min), and 50% methylene chloride in DMF (1×2 min). The following protocol is used to deprotect the Boc group. 5% m-cresol in trifluoroacetic acid (2×2 min), 50% methylene chloride in DMF (3×2 min), 5% diisopropylethylamine in methylene chloride (2×2 min), and methylene chloride (2×2 min).

### Example 2

### Preparation of dno-718

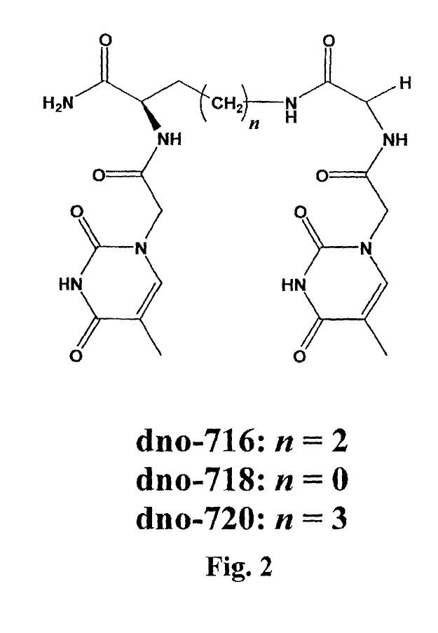

OPTIDE dimer dno-718 (cf. FIG. 2) was prepared in a manner analogous to that of dno-716 (cf. Example 1), except that the solid-phase synthesis utilised the commercially available N^{α}-Fmoc-N^{β}-Boc-L-diamino-propionic acid (N^{α}-Fmoc-L-Dap(Boc)-OH (Bachem-Switzerland) to incorporate the C-terminal backbone unit. Final cleavages (cf. Example 1) of resin-bound dno-718 gave approximately 91 mg of the product. Molecular weight (M+H⁺): 493.5.

### Example 3

### Preparation of dno-717

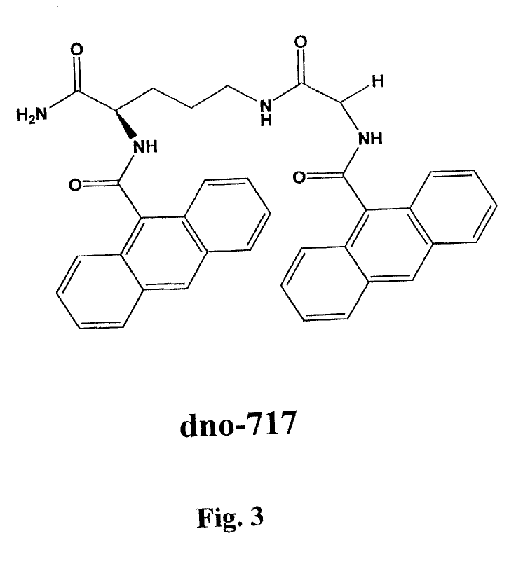

OPTIDE dimer dno-717 (cf. FIG. 3) was prepared in a manner analogous to that of dno-716 (cf. Example 1), except that for incorporation of the side-chain units in dno-717, the commercially available anthracene-9-carboxylic acid was used instead of thymine-1-acetic acid. Final cleavages (cf. Example 1) of resin-bound dno-717 gave approximately 103 mg of the product. Molecular weight (M+H⁺): 597

### Example 4

### Preparation of dno-720

OPTIDE dimer dno-720 (cf. FIG. 2) was prepared in a manner analogous to that of dno-716 (cf. Example 1), except that for incorporation of the C-terminal backbone unit in dno-720, i.e., L-Lys, N^{α}-Fmoc-L-Lys(N^{ε}-Boc)-OH (Bachem-Switzerland) was used instead of N^{α}-Fmoc-L-Orn(N^{δ}-Boc)-OH. Final cleavages (cf. Example 1) of resin-bound dno-720 gave approximately 96 mg of the product. Molecular weight (M+H⁺): 535

### Example 5

### Preparation of pna-1000

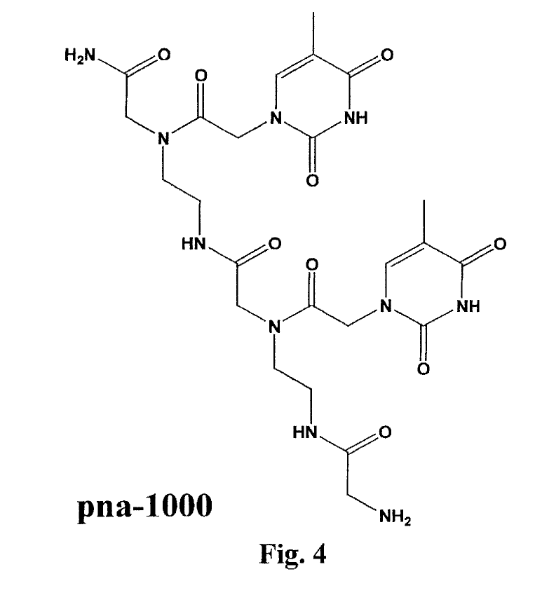

OPTIDE dimer pna-100 (c.f., FIG. 4) was synthesised in a manner similar to that described earlier for a number of peptide nucleic acids [Christensen, L. et al. J. Peptide Sci. 3, 175-183 (1995)] using two different monomer subunits. The first one was the commercially available Boc-T(aeg)-OH (Millipore). The second one was the commercially available Boc-Gly-OH (Bachem-Switzerland) used to incorporate Gly as the N-terminal backbone unit. To obtain a C-terminal amide, the dimer was assembled on a p-methylbenzhydrylamine (MBHA) 1% divinylbenzene crosslinked polystyrene resin (Peninsula, England) (100-200 mesh) initially loaded with 0.42 mmol amino groups per gram resin. 2-(1H-benzotriazol-1-yl)-1,1,3,3-tetramethyluronium hexafluorophosphate (HBTU) (Richelieu, Canada) activation in combination with in situ neutralisation allowed efficient incorporation of both backbone residues when the couplings were performed in 50% (v/v) pyridine in N,N-dimethylformamide with a monomer concentration of 0.10 M. The deprotections of N^{δ}-Boc groups as well as cleavage from the resin were accomplished as described for dno-716 (c.f. Example 1). The dimer was extracted from the resin with 50% (v/v) trifluoroacetic acid in methylene chloride and was obtained as a reddish oilr (ca. 200 mg) after evaporation of the solvents. (M+H⁺): 608.6.

### Example 6

### Preparation of pna-1001

OPTIDE dimer pna-1001 (cf. FIG. 6) is prepared in a manner analogous to pna-1000 (cf. Example 5), except that an N-methyl-thymine monomer is used instead of the thymine monomer.

### Example 7

### Preparation of dno-816

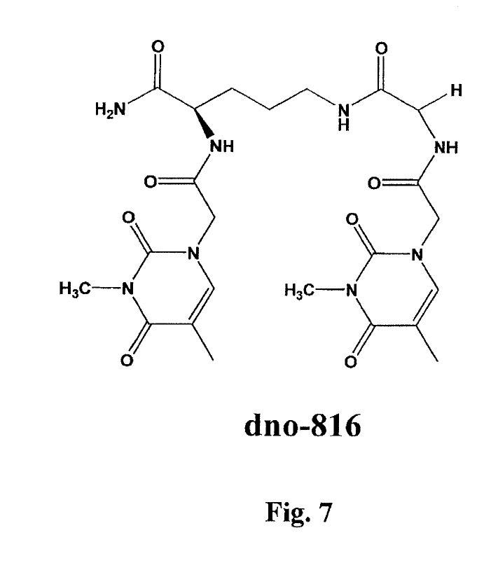

OPTIDE dimer dno-816 (cf. FIG. 7) is prepared in a manner analogous to dno-716 (cf. Example 1), except that for incorporation of the side-chain units in dno-816, N-methyl-thymine-1-acetic acid is used instead of thymine-1-acetic acid.

### Example 8

### Preparation of dno-817, dno-818, dno-819, dno820, and dno-821

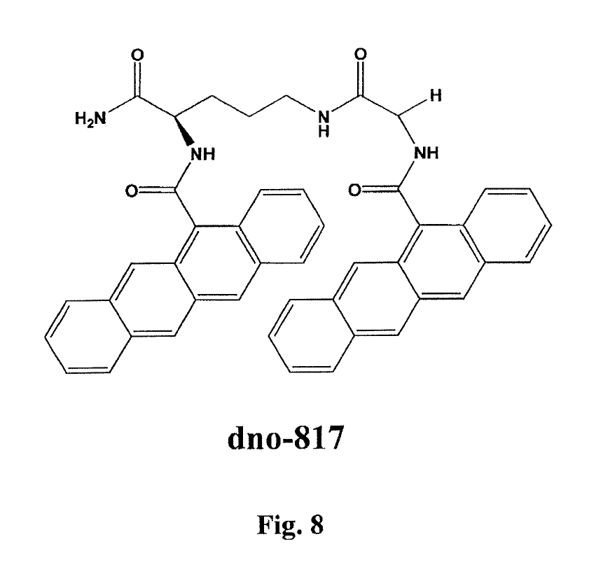

OPTIDE dimers dno-817 (cf. FIG. 8), dno-818, dno-819, dno-820 and dno-821 (cf. FIG. 9), respectively, are prepared in a manner analogous to dno-716 (cf. Example 1), except that for incorporation of the side-chain units in dno-816, tetracene-carboxylic acid is used instead of thymine-1-acetic acid, and for incorporation of the side-chain units in dno-818, dno819, dno-820 and dno-821, respectively, the acridizinium-carboxylic acid in question is used instead of thymine-1-acetic acid.

### Example 9

### Preparation of Glass Substrates Coated with Peptide Film

The peptide (25 mg) was dissolved in a solution of hexafluoroisopropanol-trifluoroacetic acid-methylene chloride (76:18:6 (v/v/v), 400 μl), and the resulting red solution was filtered through a syringe filter (0.7 μm pore size). To prepare a film with a thickness of about 10 μm, 10-14 drops of the solution were cast on a 20 mm glass plate in a desiccator and vacuum was applied immediately after. The film was dried for 30 min in the desiccator and then transferred to an oven at 90° C. overnight. The thickness of the film in question was measured with a Dektak profiler. Films with a thickness ranging from 1 to 15 μm were prepared. The thickness of the individual films examined typically had a variation in the thickness of less than ±3%. When examining the films in a polarisation microscope at room temperature, they exhibit no birefringence.

### Example 10

### Absorption Changes in Thymine Containing Peptide Films on UV Irradiation

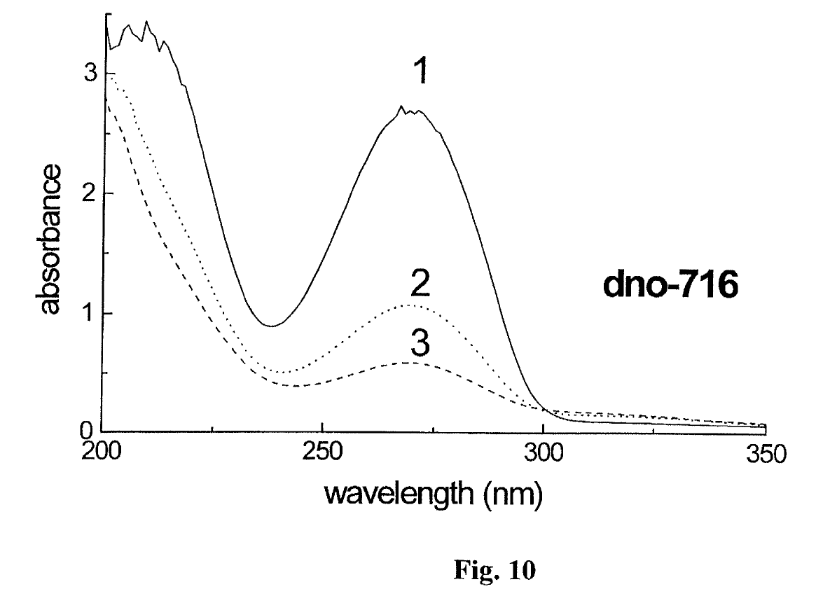

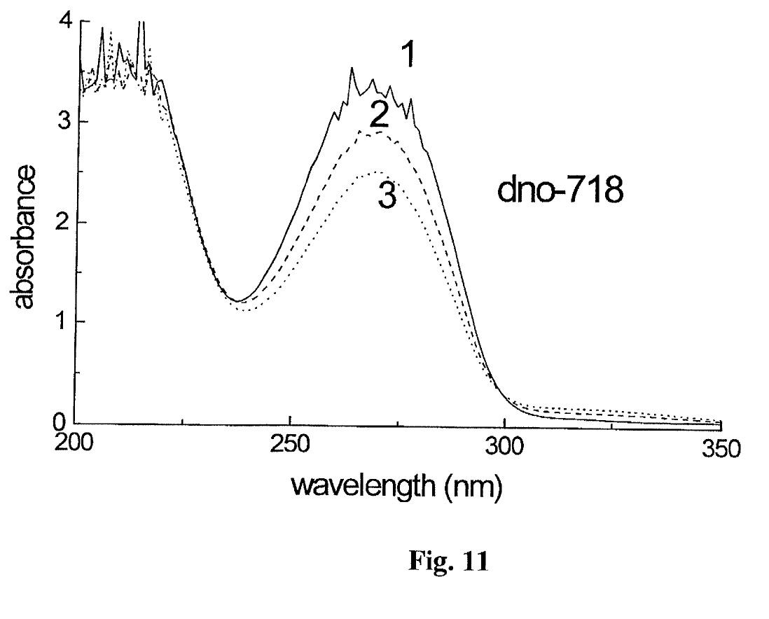

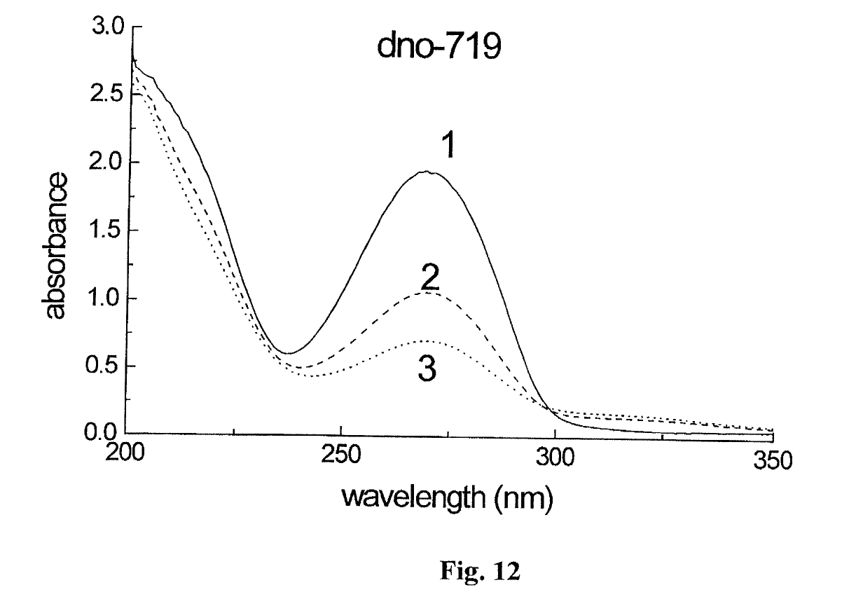

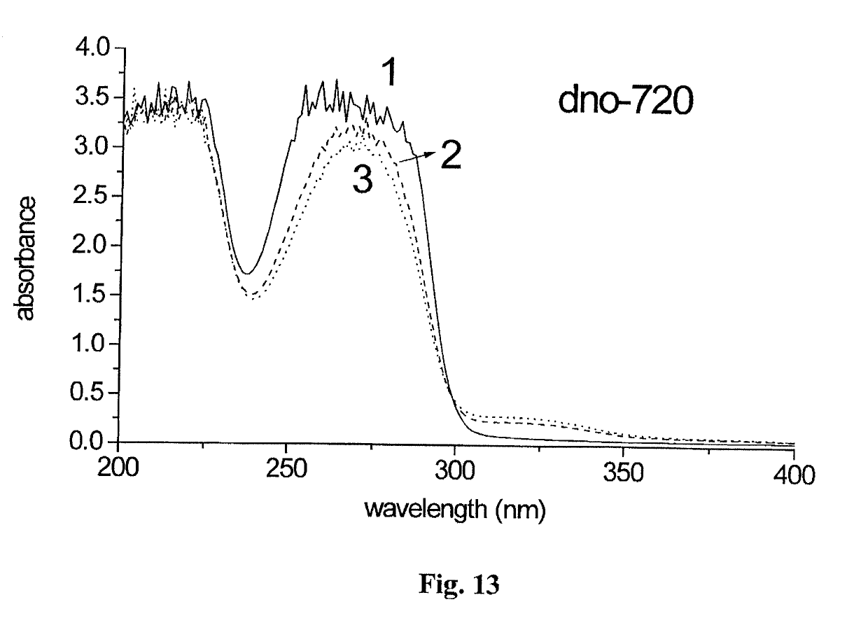

Thymine containing peptides have been synthesised using the techniques described before. Four different peptide backbones have been fabricated so far: a diaminopropionic acid-based (dno-718), a diaminobutyric acid-based (dno-719), ornithine-based (dno-716), and lysine-based (dno-720). These have 4, 5, 6 and 7 bonds between the side chains respectively. Films have been made from these peptides and have been irradiated at 248 nm from an excimer laser. The absorption spectra for three dimers before and after irradiation are shown in FIGS. 10-13. Curve 1 in FIGS. 10-13 shows the absorption spectrum before irradiation, curve 2 shows the absorption spectrum after irradiation with 1500 pulses and curve 3 shows the absorption spectrum after 3000 pulses of irradiation. The total energy of the irradiating light after 1500 pulses was estimated to be 2 J/cm² and after 3000 pulses to be 4 J/cm².

It can be seen that the backbone plays an role in the change in the absorption. There seems to be a critical main chain length for effective dimerisation. Too short or too long backbones are not effective in photodimerisation. There seems to be an optimum for this chromophore around the ornithine backbone (dno-716). In this case, the absorbance decreases dramatically from approximately 3.0 before irradiation to less than 0.5 after irradiation.

### Example 11

### Water Soluble Films

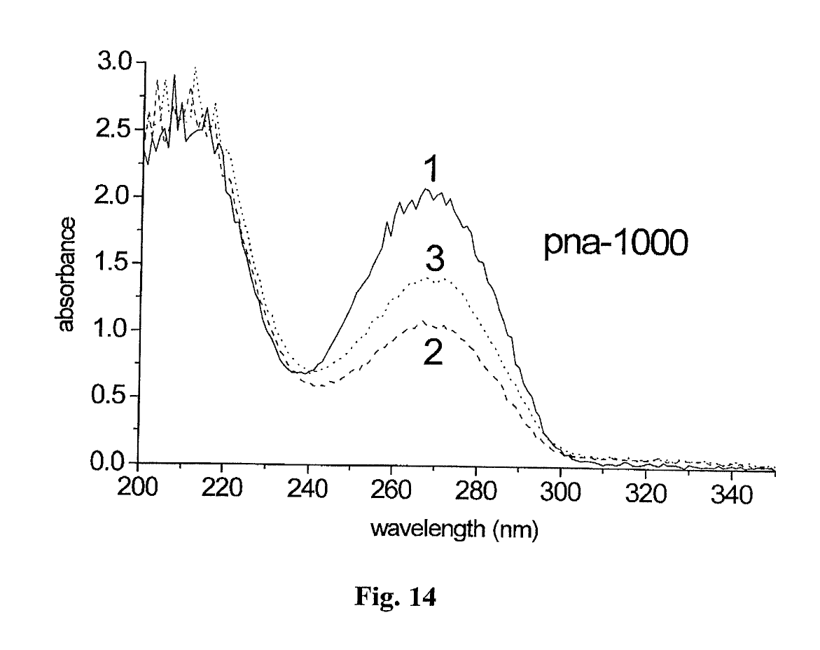

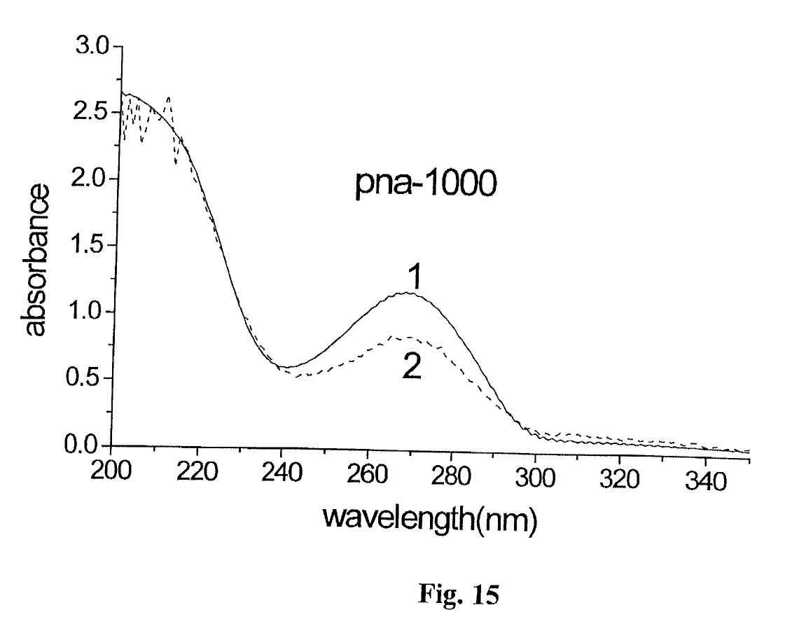

Thin films of pna optides containing thymine were also fabricated as described in Example 9. This material is soluble both in organic solvents and in water. Thin films of this material have been irradiated at 266 nm from a commercial frequency-quadrupled YAG laser. The total energy incident on the film is approximately 5-10 J/cm², the irradiation time being 600 s. FIGS. 14 shows the absorption spectrum of a thin film of pna-1000 dissolved in HFIP before irradiation shown as the curve 1. Curve 2 shows the absorption spectrum of the same film after irradiation at 266 nm. Curve 3 shows the absorption spectrum of the same film after being kept at a temperature of 100° C. for 72 hours. FIG. 15 shows the absorption spectra of a thin film of pna-1000 obtained from a water solution. The spectrum before irradiation is depicted as curve 1. After irradiation, the film was kept at a temperature of 100° C. for 96 hours. Curve 2 in FIG. 15 shows the absorption spectrum after this treatment. It is clearly seen that the absorption spectra show only a small change at this temperature.

### Example 12

### Absorption Changes in Anthracene Containing Peptide Films on UV Irradiation

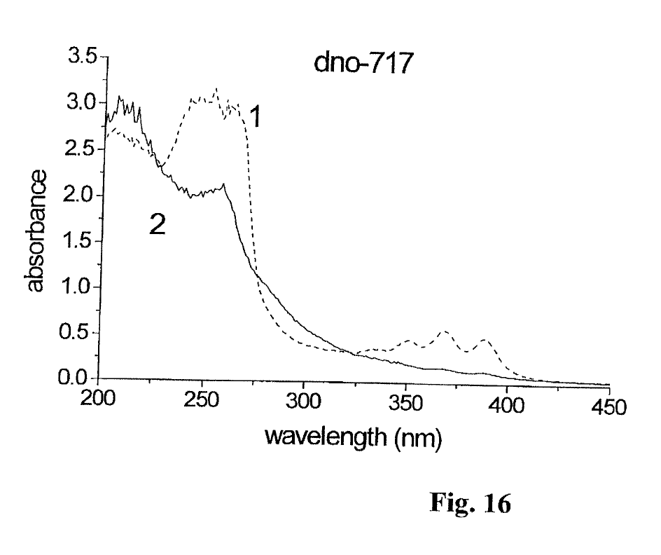

To test the general idea, anthracene molecules have also been attached to an ornithine backbone. This material is denoted dno-717. The film (prepared as described in Example 9) was then irradiated with 360 nm from a krypton ion laser for 60 s. A change in the absorption spectrum could easily be noticed. FIG. 16 shows the absorption spectrum of the anthracene monomers attached to an ornithine-glycine backbone as curve 1. The absorption spectrum of the film after irradiation at 350 nm from a krypton laser is shows as curve 2.

### Example 13

### Recording and Read-Out of “Bits”

“Bits” recorded at a wavelength of 350 nm were read out at the same wavelength of 350 nm at reduced intensity (85/5=17 times) for more than 400 cycles without any noticeable deterioration. The same technique can be used to fabricate digital storage discs for the blue, using either acridizinium or benzacridizinium (16) as the photodimerizable chromophore. This chromophore absorbs between 400 and 450 nm and can be erased with irradiation at shorter wavelengths (e.g. about 200-250 nm).

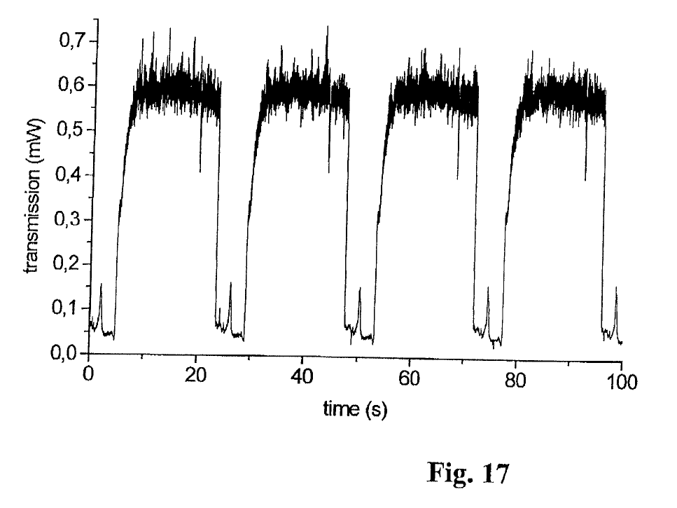

A thin film of dno-717 was deposited close to the periphery of a Petri dish as described in Example 9. The central part of the film was then exposed to 350 nm radiation from a krypton laser. The intensity of the beam was 85 mW/cm² and the exposure time was 20 mins. After this, the intensity of the laser was reduced to 5 mW/cm². The Petri dish was mounted on a step motor and was driven at the rate of 1 rev per 5 seconds. The transmitted light was recorded using a power meter. FIG. 17 shows the last of the 400 cycles. The largest absorption is due to the unexposed film, and the central decrease in absorption is due to the localised areas in which the chromophores are dimerised.

### Example 14

### Holographic Recording in dno-717

In order to investigate the suitability of thin films of the peptide dimers for holographic storage, a measurement was performed with a film of dno-717 prepared (prepared as described in Example 9). An argon ion laser beam at 360 nm was divided into with a beamsplitter and the two beams were made to interfere on the film of dno-717. A HeNe laser beam at 633 nm was used for the readout of the diffraction grating. A diffraction efficiency of 0.1% was obtained after irradiation for 300 s. The low diffraction efficiency is believed to be due to the small change in the absorbance, as well as the probe wavelength being far from the absorption wavelength, thus probing very small changes in the refractive index at this wavelength.

### Example 15

### Surface Relief in Peptide Dimers

The film discussed in Example 14 was then examined with an atomic force microscope. A sinusoidal surface relief corresponding to the optical spatial frequency was observed. FIG. 18 shows an atomic force microscopic scan of the film. The scanning area was 10 μm by 10 μm. The spatial frequency is thus approximately 1000 lines/mm. Typical depths of over 90 nm were obtained in this case.

In order to investigate whether peaks or trenches are created during the irradiation process, a monomeric films of an anthracene containing peptide monomer is exposed to UV light from a krypton ion laser at a wavelength of 350 nm through a transmission mask. The intensity of the beam was 85 mW/cm² and the exposure time was 20 mins. The mask consists of dark lines which are approximately 10 microns wide and transparent lines which are approximately 20 microns wide. After irradiation, when the irradiated films is examined with an atomic force microscope, a surface relief corresponding to the spatial frequency of the mask was found to be created. The exposed area displays trenches. This might be due to the volume decrease in the dimerisation process. FIG. 19 shows an atomic force microscopic scan of the exposed film. This process may be significant in the replication of narrow spatial structures fabricated through irradiation.

### Example 16

### Environmental Stability of the Surface Relief

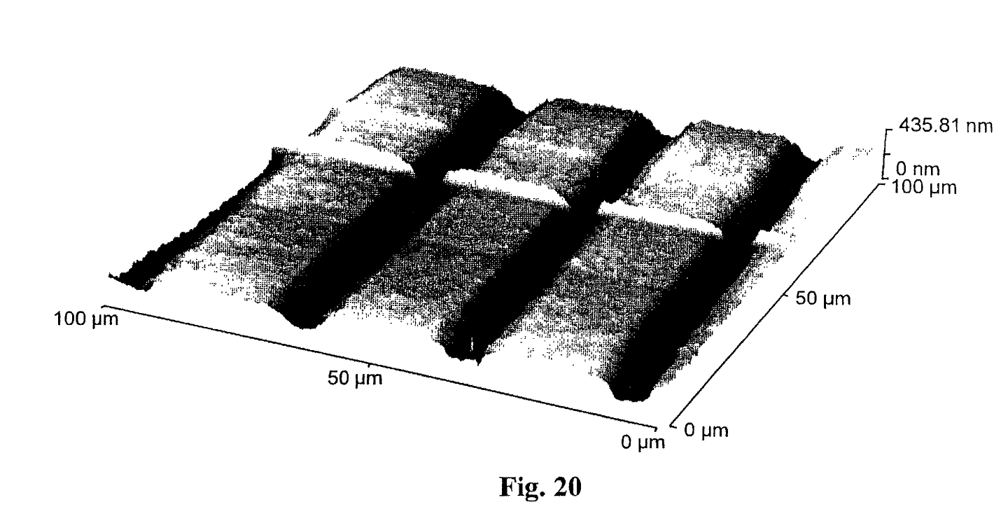

The film discussed in example 15 was then kept in an oven at a temperature of 110° C. for nearly 16 hours. An atomic force microscopic scan of the film after this treatment was performed. FIG. 20 shows a scan of with the atomic force microscope. This shows that the surface relief is also stable at high temperatures.

1. A method for optical storage of information in a material and optical read-out of the information from said material, said material comprising a compound having at least two chromophores and a linkage connecting the chromophores, said method comprising:
(a) irradiation of localised areas of the material at a first wavelength with a first intensity thereby inducing a cycloaddition reaction between chromophores in said localised areas of the material whereby a cycloadduct is formed, and
(b) irradiation of the material at a second wavelength with a second intensity thereby rendering it possible to extract the information, or a part thereof, from the material.

2. A method according to claim 1, wherein the chromophores contain at least one double bond which can add to another double bond, thereby forming the cycloadduct.

3. A method according to claim 2, wherein the chromophores are compounds selected from acyclic, cyclic, bicyclic, tricyclic, tetracyclic, polycyclic, heterocyclic, aromatic, polyaromatic and heteroaromatic compounds containing at least one double bond.

4. A method according to claim 3, wherein the chromophores are selected from aromatic, polyaromatic and heteroaromatic compounds

5. A method according to claim 1, wherein the linkage between the at least two chromophores is based on (a) amino acids or peptides; (b) ribonucleotides, deoxyribonucleotides, deoxyribonucleic acids, ribonucleic acids, or derivatives thereof; and (c) polymer nucleic acids (PNA).

6. A method according to claims 1, wherein the linkage between two chromophores represent a length of 4-30 bonds.

7. A method according to claim 1, wherein the compound comprises 2-24 segments of the following formula G 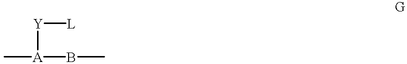
wherein
L is the photodimerisable chromophore;
Y-A-B is a part of the linkage between two chromophores, wherein
Y is a linking group selected from —O—(CH₂)ₚ—C(═O)—NH—, —O—(CH₂)ₚ—NH—C(═O)—, —O—(CH₂)ₚ—C(═O)—, —O—(CH₂)ₚ—NH—, —(CH₂)ₚ—C(═O)—NH—, —(CH₂)ₚ—NH—C(═O)—, —(CH₂)ₚ—C(═O)—, —(CH₂)ₚ—NH—, —OOC—(CH₂)ₚ—C(═O)—NH—, —OOC—(CH₂)ₚ—NH—C(═O)—, —OOC—(CH₂)ₚ—C(═O)—, —OOC—(CH₂)ₚ—NH—, —NH—(CH₂)ₚ—C(═O)—NH—, —N(C₁₋₆-alkyl)-(CH₂)ₚ—C(═O)—NH—, —NH—(CH₂)ₚ—NH—C(═O)—, —N(C₁₋₆-alkyl)-(CH₂)ₚ—NH—C(═O)—, —NH—(CH₂)ₚ—C(═O)—, —N(C₁₋₆-alkyl)-(CH₂)ₚ—C(═O)—, —NH—(CH₂)ₚ—NH—, —N(C₁₋₆-alkyl)-(CH₂)ₚ—NH—, —NH—C(═O)—(CH₂)_{y}—C(═O)—NH—, —N(C₁₋₆-alkyl)-C(═O)—(CH₂)ₚ—C(═O)—NH—, —NH—C(═O)—(CH₂)ₚ—NH—C(═O)—, —N(C₁₋₆-alkyl)-C(═O)—(CH₂)ₚ—NH—C(═O)—, —NH—C(═O)—(CH₂)ₚ—C(═O)—, —N(C₁₋₆-alkyl)-C(═O)—(CH₂)ₚ—C(═O)—, —NH—C(═O)—(CH₂)ₚ—NH—, and —N(C₁₋₆-alkyl)-C(═O)—(CH₂)ₚ—NH—, wherein p is 0-5, preferably 0-2;
A is selected from a nitrogen atom and a group C—R in which R is selected from hydrogen and optionally substituted C₁₋₄-alkyl; and
B is a chain consisting of groups selected from CHR² and C═O, wherein R² is selected from side chains of α-amino acids, optionally substituted C₁₋₆-alkyl, hydroxy, optionally substituted C₁₋₆-alkoxy, halogen, cyano, amino, mono- or di(optionally substituted C₁₋₆-alkyl)amino, mono- or di(optionally substituted C₁₋₆-alkyl)amino-C₁₋₆-alkyl, (optionally substituted C₁₋₆-alkyl)carbonylamino, (optionally substituted C₁₋₆-alkyl)carbonylamino-C₁₋₆-alkyl, aminocarbonyl, aminocarbonyl-C₁₋₆-alkyl, mono- or di(optionally substituted C₁₋₆-alkyl)aminocarbonyl, mono- or di(optionally substituted C₁₋₆-alkyl)aminocarbonyl-C₁₋₆-alkyl, optionally substituted C₁₋₆-acyl, optionally substituted C₁₋₆-acyloxy, carboxy, and (optionally substituted C₁₋₆-alkoxy)carbonyl; said chain B optionally being interrupted, initiated, or terminated by one or more groups selected from —O—, and —NR³—, wherein R³ is selected from hydrogen, C₁₋₆-alkyl, mono- or di(optionally substituted C₁₋₆-alkyl)amino-C₁₋₆-alkyl, (optionally substituted C₁₋₆-alkyl)carbonylamino-C₁₋₆-alkyl, aminocarbonyl-C₁₋₆-alkyl, mono- or di(optionally substituted C₁₋₆-alkyl)aminocarbonyl, mono- or di(optionally substituted C₁₋₆-alkyl)aminocarbonyl-C₁₋₆-alkyl, (optionally substituted aryl)-C₁₋₆-alkoxycarbonyl, optionally substituted C₁₋₆-acyl, and optionally substituted C₁₋₆-alkoxycarbonyl.

8. A method according to claim 7, wherein the backbone moiety -A-B- together with at least a part of the linking group Y is derived from one or more amino acid(s).

9. A method according to claim 8, wherein the one or more amino acid(s) are selected from ornithine, lysine, homolysine, diaminobutyric acid, and diaminopropionic acid.

10. A method according to claim 1, wherein the compound is as defined in claim 19.

11. A method according to claim 1, wherein the compound is as defined in claim 24.

12. A method according to claim 1, wherein the material comprises a polymeric component.

13. A method according to claim 1, wherein the compound constitutes at least 80%, such as at least 90%, in particular at least 95%, of the material.

14. A method according to claim 1, wherein the first and second specific wavelengths are substantially the same.

15. A method according to claim 1, wherein the first intensity is at least 2 times higher than the second intensity.

16. A method according to claim 1, wherein the information, or a part thereof, is extracted from the material by measuring the reflection, refraction, transmission or diffraction of said irradiation of the second wavelength by the material.

17. A method according to claim 1, wherein the first and second wavelengths differs by at least 10 nm.

18. A method according to claim 1, wherein the method further comprises the later step of irradiation of the material at third wavelength thereby inducing a photodissociation thereby reforming the two chromophores.

19. A compound of the formula X 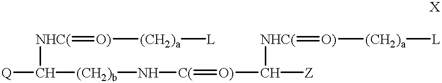
wherein
a is 0-2 and b is 1-5;
L is selected from the group consisting of N—(C₁₋₆-alkyl)-thymine, anthracene, acridizinium salts, and tetracene;
Q is selected from the group consisting of hydrogen, carboxy, aminocarbonyl, mono- or di(C₁₋₂₄-alkyl)aminocarbonyl, (a chain of 1-5 amino acid(s))-carboxy;
Z is selected from the group consisting of side chains of α-amino acids, hydrogen, methyl, cyanomethyl, ethyl, 1-propyl, 2-propyl, 2-methyl-1-propyl, 2-hydroxy-2-methyl-1-propyl, 1-butyl, 2-butyl, methylthioethyl, benzyl, p-amino-benzyl, p-iodo-benzyl, p-fluoro-benzyl, p-bromo-benzyl, p-chloro-benzyl, p-nitro-benzyl, 3-pyridylmethyl, 3,5-diiodo-4-hydroxy-benzyl, 3,5-dibromo-4-hydroxy-benzyl, 3,5-dichloro4-hydroxy-benzyl, 3,5-difluoro-4-hydroxy-benzyl, 4-methoxy-benzyl, 2-naphtylmethyl, 1-naphtylmethyl, 3-indolylmethyl, hydroxymethyl, 1-hydroxyethyl, mercaptomethyl, 2-mercapto-2-propyl, 4-hydroxybenzyl, aminocarbonylmethyl, 2-aminocarbonylethyl, carboxymethyl, 2-carboxyethyl, aminomethyl, 2-aminoethyl, 3-amino-propyl, 4-amino-1-butyl, 3-guanidino-1-propyl, 4-imidazolylmethyl, C₁₋₂₄-alkyl, N—(C₁₋₂₄-acyl)-amino-(C₁₋₆-alkyl), and (a chain of 1-5 amino acid(s))-amino-(C₁₋₆-alkyl).

20. A compound according to claim 19, wherein
b is 2-4;
Q is selected from the group consisting of hydrogen, carboxy, aminocarbonyl, mono- or di(C₁₋₁₈-alkyl)aminocarbonyl, (a chain of 1-5 amino acid(s))-carboxy;
Z is selected from the group consisting of side chains of α-amino acids, hydrogen, methyl, cyanomethyl, ethyl, 1-propyl, 2-propyl, 2-methyl-1-propyl, 2-hydroxy-2-methyl-1-propyl, 1-butyl, 2-butyl, methylthioethyl, benzyl, p-amino-benzyl, p-iodo-benzyl, p-fluoro-benzyl, p-bromo-benzyl, p-chloro-benzyl, p-nitro-benzyl, 3-pyridylmethyl, 3,5-diiodo-4-hydroxy-benzyl, 3,5-dibromo-4-hydroxy-benzyl, 3,5-dichloro4-hydroxy-benzyl, 3,5-difluoro-4-hydroxy-benzyl, 4-methoxy-benzyl, 2-naphtylmethyl, 1-naphtylmethyl, 3-indolylmethyl, hydroxymethyl, 1-hydroxyethyl, mercaptomethyl, 2-mercapto-2-propyl, 4-hydroxybenzyl, aminocarbonylmethyl, 2-aminocarbonylethyl, carboxymethyl, 2-carboxyethyl, aminomethyl, 2-aminoethyl, 3-amino-propyl, 4-amino-1-butyl, 3-guanidino-1-propyl, 4-imidazolylmethyl, C₁₋₁₈-alkyl, N—(C₁₋₁₈-acyl)-amino-(C₁₋₆-alkyl), and (a chain of 1-5 amino acid(s))-amino-(C₁₋₆-alkyl).

21. A compound according to claim 20, wherein
Q is selected from the group consisting of hydrogen, carboxy, aminocarbonyl, mono- or di(C₁₋₁₂-alkyl)aminocarbonyl, (a chain of 1-5 amino acid(s))-carboxy;
Z is selected from the group consisting of side chains of α-amino acids, hydrogen, methyl, cyanomethyl, ethyl, 1-propyl, 2-propyl, 2-methyl-1-propyl, 2-hydroxy-2-methyl-1-propyl, 1-butyl, 2-butyl, methylthioethyl, benzyl, p-amino-benzyl, p-iodo-benzyl, p-fluoro-benzyl, p-bromo-benzyl, p-chloro-benzyl, p-nitro-benzyl, 3-pyridylmethyl, 3,5-diiodo-4-hydroxy-benzyl, 3,5-dibromo-4-hydroxy-benzyl, 3,5-dichloro-4-hydroxy-benzyl, 3,5-difluoro-4-hydroxy-benzyl, 4-methoxy-benzyl, 2-naphtylmethyl, 1-naphtylmethyl, 3-indolylmethyl, hydroxymethyl, 1-hydroxyethyl, mercaptomethyl, 2-mercapto-2-propyl, 4-hydroxybenzyl, aminocarbonylmethyl, 2-aminocarbonylethyl, carboxymethyl, 2-carboxyethyl, aminomethyl, 2-aminoethyl, 3-amino-propyl, 4-amino-1-butyl, 3-guanidino-1-propyl, 4-imidazolylmethyl, C₁₋₁₂-alkyl, N—(C₁₋₁₂-acyl)-amino-(C₁₋₆-alkyl), and (a chain of 1-5 amino acid(s))-amino-(C₁₋₆-alkyl).

22. A compound according to claim 21, wherein b is 3.

23. A compound according to claim 21, wherein Q is aminocarbonyl and Z is hydrogen or the side chain of an α-amino acids.

24. A compound of the formula XI 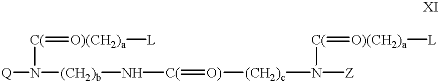
wherein
a is 0-2, b is 1-3 and c is 1-3;
L is selected from the group consisting of N—(C₁₋₆-alkyl)-thymine, anthracene, an acridizinium salt, and tetracene;
Q is selected from the group consisting of hydrogen, carboxy-C₁₋₃-alkyl, aminocarbonyl-C₁₋₃-alkyl, mono- or di(C₁₋₂₄-alkyl)aminocarbonyl-C₁₋₃-alkyl; C₁₋₂₄-alkoxycarbonyl-C₁₋₃-alkyl, and (a chain of 1-5 amino acid(s))-carboxy-C₁₋₃-alkyl;
Z is selected from the group consisting of hydrogen, amino-C₁₋₄-alkyl, N-mono or di(C₁₋₂₄-alkyl)-amino-C₁₋₄-alkyl, C₁₋₂₄-acylamino-C₁₋₄-alkyl, and (a chain of 1-5 amino acids)-amino-C₁₋₄-alkyl.

25. A compound according to claim 24, wherein
Q is selected from the group consisting of hydrogen, carboxy-C₁₋₂-alkyl, aminocarbonyl-C₁₋₂-alkyl, mono- or di(C₁₋₁₈-alkyl)aminocarbonyl-C₁₋₂-alkyl; C₁₋₁₈-alkoxycarbonyl- C₁₋₂-alkyl, and (a chain of 1-5 amino acid(s))-carboxy-C₁₋₂-alkyl;
Z is selected from the group consisting of hydrogen, amino-C₁₋₃-alkyl, N-mono- or di(C₁₋₁₈-alkyl)-amino-C₁₋₃-alkyl, C₁₋₁₈-acylamino-C₁₋₃-alkyl, and (a chain of 1-5 amino acids)-amino-C₁₋₃-alkyl.

26. A compound according to claim 25, wherein
Q is selected from the group consisting of hydrogen, carboxy-CH₂, aminocarbonyl-CH₂, mono- or di(C₁₋₁₂-alkyl)aminocarbonyl-CH₂, C₁₋₁₂-alkoxycarbonyl-CH₂, and (a chain of 1-5 amino acid(s))-carboxy-CH₂;
Z is selected from the group consisting of hydrogen, amino-(CH₂)₂, N-mono- or di(C₁₋₁₂-alkyl)-amino-(CH₂)₂, C₁₋₁₈-acylamino-(CH₂)₂, and (a chain of 1-5 amino acids)-amino-(CH₂)₂.

27. A compound according to claim 26, wherein b is 2-3 and c is 1-2.

28. A compound according to claim 27, wherein b is 2 and c is 1.

29. A compound according to claim 24, wherein
Q is H₂NC(═O)CH₂ and Z is H₂NCH₂C(═O)NH(CH₂)₂.

30. A material comprising a compound according to claim 19.

31. A material comprising a compound according to claim 24.

32. An optical storage medium comprising a compound according to claim 19 and a substrate.

33. An optical storage medium comprising a compound according to claim 24 and a substrate.
